(19) United States
(12) Patent Application Publication
(10) Pub. No.: US 2009/0021637 A1
(43) Pub. Date: Jan. 22, 2009

(54) Image processing device, image processing method, program, and display device

(75) Inventors: Tetsuro Tanaka, Tokyo (JP); Takeshi Fujimori, Ibaraki (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/218,421

(22) Filed: Jul. 15, 2008

(30) Foreign Application Priority Data
Jul. 18, 2007 (JP) P2007-186563

(51) Int. Cl. H04N 7/01

(52) U.S. Cl. 348/452; 348/E07.003

(57) ABSTRACT

An image processing device for obtaining motion information indicating a motion of an image, the image processing device including: a motion estimating section configured to obtain motion information of a pixel of interest and output the motion information of the pixel of interest, and obtain an evaluation value for evaluating the motion information of the pixel of interest, obtain an evaluation value for evaluating the motion information of the pixel of interest, determine reliability of the motion information of the pixel of interest, and output reliability information indicating the reliability.

### CROSS REFERENCES TO RELATED APPLICATIONS

The present invention contains subject matter related to Japanese Patent Application JP 2007-186563 filed with the Japan Patent Office on Jul. 18, 2007, the entire contents of which being incorporated herein by reference.

### BACKGROUND OF THE INVENTION

1. Field of the Invention

The present invention relates to an image processing device, an image processing method, a program, and a display device, and particularly to an image processing device, an image processing method, a program, and a display device that can for example obtain reliability information indicating reliability of motion information indicating a motion of an image with higher accuracy and at lower cost.

2. Description of the Related Art

For example, in IP (Interlace Progressive) conversion that converts an interlaced image scanned by interlaced scanning to a progressive image scanned by non-interlaced scanning, interpolation for pixels without a pixel value is performed in each field of the interlaced image. Thereby a field that has pixel values in only odd lines (odd-numbered horizontal lines) or even lines (even-numbered horizontal lines) is converted to a frame that has pixel values in both the odd lines and the even lines.

As methods for the pixel interpolation in the IP conversion, there are methods referred to as intra-field interpolation and inter-field interpolation.

The intra-field interpolation and the inter-field interpolation set pixels that do not have a pixel value in a field of an interlaced image as interpolation object pixels for which to perform interpolation, and obtain pixel values (the interpolation values of the pixel values) for the interpolation object pixels using the pixel values of pixels that have a pixel value.

In the present specification, a field and a frame from a vertical synchronizing signal to a next vertical synchronizing signal will both be also referred to collectively as pictures.

In addition, as appropriate, an interpolation object pixel to which attention is directed among interpolation object pixels will hereinafter be referred to as a pixel of interest, and a picture (a field or a frame) including the pixel of interest will hereinafter be referred to as a picture of interest.

The intra-field interpolation obtains the pixel value of the pixel of interest using the pixel values of pixels in the vicinity of the pixel of interest among the pixels of the picture of interest.

On the other hand, the inter-field interpolation obtains the pixel value of the pixel of interest using the pixel value of a pixel in a preceding picture preceding (temporally in the past) the picture of interest by one picture and the pixel value of a pixel in a succeeding picture succeeding (temporally in the future) the picture of interest by one picture as well as the motion vector of the pixel of interest.

Specifically, the inter-field interpolation obtains the pixel value of the pixel of interest using the pixel value of a pixel among the pixels of the preceding picture which pixel is at a position shifted from the position of the pixel of interest by an amount corresponding to the motion vector of the pixel of interest and the pixel value of a pixel among the pixels of the succeeding picture which pixel is at a position shifted from the position of the pixel of interest by the amount corresponding to the motion vector of the pixel of interest.

As described above, the inter-field interpolation uses the motion vector of the pixel of interest to interpolate the pixel of interest (the pixel value of the pixel of interest). Thus, when the motion vector of the pixel of interest represents a wrong motion, a proper interpolation value cannot be obtained as the pixel value of the pixel of interest. As a result, the image quality of the progressive image is degraded.

Accordingly, there is an IP conversion that uses a motion vector detected for a block of interest to which attention is directed and a motion vector detected for a block on the periphery of the block of interest, obtains reliability information indicating reliability (accuracy) of the motion vector detected for the block of interest on the basis of coincidence between these motion vectors, mixes an interpolation value obtained by intra-field interpolation with an interpolation value obtained by inter-field interpolation according to the reliability information, and sets a result of the mixture as the pixel value of a pixel of interest (see Japanese Patent Publication No. Hei 08-015334, for example).

### SUMMARY OF THE INVENTION

As a method for detecting a motion vector, there is a method referred to as block matching using groups of a plurality of pixels. Supposing that a group of a plurality of pixels used to detect a motion vector is referred to as a macroblock (MB), in block matching, a sum total (hereinafter referred to as a motion error) of differences (absolute values of the differences) between the pixel values of pixels forming a macroblock of a certain picture and the pixel values of pixels forming a macroblock of another picture is obtained while moving the macroblock. Then, a positional relation between a macroblock of the certain picture and a macroblock of the other picture when the motion error becomes a minimum is obtained as the motion vector.

In block matching, the larger the size of macroblocks (the larger the number of pixels of a macroblock), the stronger the possibility that a reliable motion vector can be obtained.

However, when the size of macroblocks is increased, an amount of calculation necessary to determine a motion error is increased. For real-time processing, hardware that can perform processing at high speed becomes necessary, which increases device cost.

On the other hand, when the size of macroblocks is decreased, the amount of calculation necessary to determine a motion error is decreased, and thus lower cost can be achieved. However, there is a stronger possibility that a motion vector of low reliability is obtained.

When reliability information for a motion vector detected for a block of interest is obtained using only the motion vector detected for the block of interest and a motion vector detected for a block on the periphery of the block of interest among motion vectors that are highly likely to be of low reliability, the reliability information may not indicate the reliability of the motion vector accurately.

The present invention has been made in view of such a situation. It is desirable to obtain reliability information indicating reliability of motion information indicating a motion of an image with higher accuracy and at lower cost.

An image processing device or a program according to an embodiment of the present invention is an image processing device for obtaining motion information indicating a motion of an image or a program for making a computer function as an image processing device, the image processing device including motion estimating means for obtaining motion information of a pixel of interest to which attention is directed among pixels of a picture of interest to which attention is directed, using a motion vector of the pixel of interest and a motion vector of a pixel in vicinity of the pixel of interest, and outputting the motion information of the pixel of interest. An image processing device is further for obtaining an evaluation value for evaluating the motion information of the pixel of interest using motion vectors of a plurality of pixels of the picture of interest, obtaining an evaluation value for evaluating the motion information of the pixel of interest using motion vectors of a plurality of pixels of another picture adjacent to the picture of interest, determining reliability of the motion information of the pixel of interest using the evaluation values, and outputting reliability information indicating the reliability.

An image processing method according to an embodiment of the present invention is an image processing method of an image processing device for obtaining motion information indicating a motion of an image, the image processing method including a step for obtaining motion information of a pixel of interest to which attention is directed among pixels of a picture of interest to which attention is directed, using a motion vector of the pixel of interest and a motion vector of a pixel in vicinity of the pixel of interest, and outputting the motion information of the pixel of interest. The image processing method further including a step for obtaining an evaluation value for evaluating the motion information of the pixel of interest using motion vectors of a plurality of pixels of the picture of interest, obtaining an evaluation value for evaluating the motion information of the pixel of interest using motion vectors of a plurality of pixels of another picture adjacent to the picture of interest, determining reliability of the motion information of the pixel of interest using the evaluation values, and outputting reliability information indicating the reliability.

A display device according to an embodiment of the present invention is a display device for displaying an image of a broadcast program, the display device including motion estimating means for obtaining motion information of a pixel of interest to which attention is directed among pixels of a picture of interest to which attention is directed among pictures constituting the image of the broadcast program, using a motion vector of the pixel of interest and a motion vector of a pixel in vicinity of the pixel of interest, and outputting the motion information of the pixel of interest. The display device further including estimating means for obtaining an evaluation value for evaluating the motion information of the pixel of interest using motion vectors of a plurality of pixels of the picture of interest, obtaining an evaluation value for evaluating the motion information of the pixel of interest using motion vectors of a plurality of pixels of another picture adjacent to the picture of interest, determining reliability of the motion information of the pixel of interest using the evaluation values, and outputting reliability information indicating the reliability.

In the above-described embodiments of the present invention, motion information of a pixel of interest to which attention is directed among pixels of a picture of interest to which attention is directed is obtained using a motion vector of the pixel of interest and a motion vector of a pixel in vicinity of the pixel of interest. In addition, an evaluation value for evaluating the motion information of the pixel of interest is obtained using motion vectors of a plurality of pixels of the picture of interest, and an evaluation value for evaluating the motion information of the pixel of interest is obtained using motion vectors of a plurality of pixels of another picture adjacent to the picture of interest. Then, reliability of the motion information of the pixel of interest is determined using the evaluation values, and reliability information indicating the reliability is output.

Incidentally, the image processing device may be an independent device, or may be an internal block forming one device.

In addition, the program can be provided by being transmitted via a transmission medium or by being recorded on a recording medium.

According to the above-described embodiments of the present invention, it is possible to obtain reliability information indicating reliability of motion information indicating a motion of an image with higher accuracy and at lower cost.

### BRIEF DESCRIPTION OF THE DRAWINGS

FIG. 1 is a block diagram showing an example of configuration of an embodiment of a TV to which the present invention is applied;

FIG. 2 is a block diagram showing an example of configuration of an IP converting unit 15;

FIG. 3 is a diagram showing an interlaced image;

FIG. 4 is a diagram showing a progressive image;

FIG. 5 is a flowchart of assistance in explaining an IP conversion process;

FIG. 6 is a diagram of assistance in explaining a motion vector detecting method for a progressive image;

FIG. 7 is a diagram of assistance in explaining a motion vector detecting method for an interlaced image;

FIG. 8 is a block diagram showing an example of configuration of a memory unit 21;

FIG. 9 is a block diagram showing a first example of configuration of a motion estimating unit 22;

FIG. 10 is a diagram showing an example of a plurality of candidate vectors;

FIG. 11 is a diagram of assistance in explaining a process of an evaluation value calculating unit 52ₖ;

FIG. 12 is a flowchart of assistance in explaining a motion estimating process;

FIG. 13 is a block diagram showing an example of configuration of a progressive image generating unit 23;

FIG. 14 is a flowchart of assistance in explaining a progressive image generating process;

FIG. 15 is a diagram showing an image supplied from the memory unit 21 to the motion estimating unit 22;

FIG. 16 is a block diagram showing a second example of configuration of the motion estimating unit 22;

FIG. 17 is a flowchart of assistance in explaining a motion estimating process;

FIG. 18 is a block diagram showing a third example of configuration of the motion estimating unit 22;

FIG. 19 is a flowchart of assistance in explaining a motion estimating process;

FIG. 20 is a block diagram showing a fourth example of configuration of the motion estimating unit 22;

FIG. 21 is a flowchart of assistance in explaining a motion estimating process; and

FIG. 22 is a diagram showing an example of configuration of an embodiment of a computer to which the present invention is applied.

### DETAILED DESCRIPTION OF THE PREFERRED EMBODIMENTS

Preferred embodiments of the present invention will hereinafter be described. Correspondences between constitutional requirements of the present invention and embodiments described in the specification or the drawings are illustrated as follows. This description is to confirm that embodiments supporting the present invention are described in the specification or the drawings. Therefore, even when there is an embodiment described in the specification or a drawing but not described here as an embodiment corresponding to a constitutional requirement of the present invention, it does not signify that the embodiment does not correspond to the constitutional requirement. Conversely, even when an embodiment is described here as corresponding to a constitutional requirement, it does not signify that the embodiment does not correspond to constitutional requirements other than that constitutional requirement.

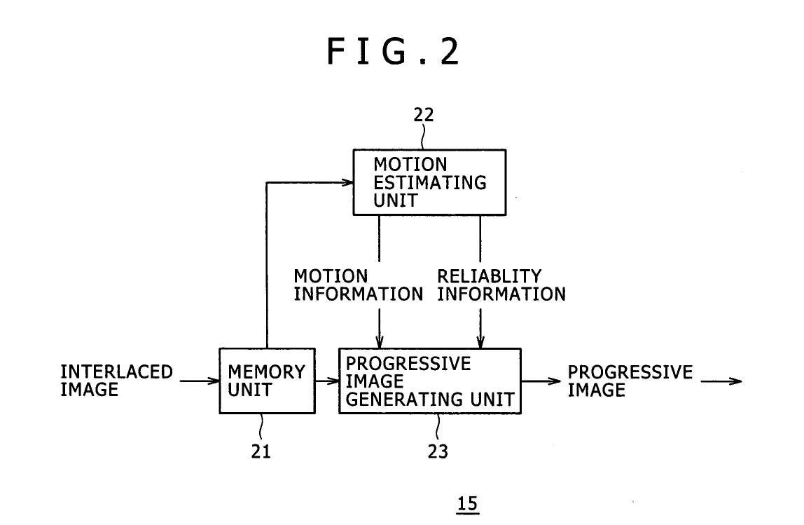

An image processing device or a program according to an embodiment of the present invention is an image processing device (for example an IP converting unit 15 in FIG. 2) for obtaining motion information indicating a motion of an image or a program for making a computer function as an image processing device, the image processing device including motion estimating means (for example a motion estimating unit 22 in FIG. 2) for obtaining motion information of a pixel of interest to which attention is directed among pixels of a picture of interest to which attention is directed, using a motion vector of the pixel of interest and a motion vector of a pixel in vicinity of the pixel of interest, and outputting the motion information of the pixel of interest, and obtaining an evaluation value for evaluating the motion information of the pixel of interest using motion vectors of a plurality of pixels of the picture of interest. The image processing device further including motion estimating means for obtaining an evaluation value for evaluating the motion information of the pixel of interest using motion vectors of a plurality of pixels of another picture adjacent to the picture of interest, determining reliability of the motion information of the pixel of interest using the evaluation values, and outputting reliability information indicating the reliability.

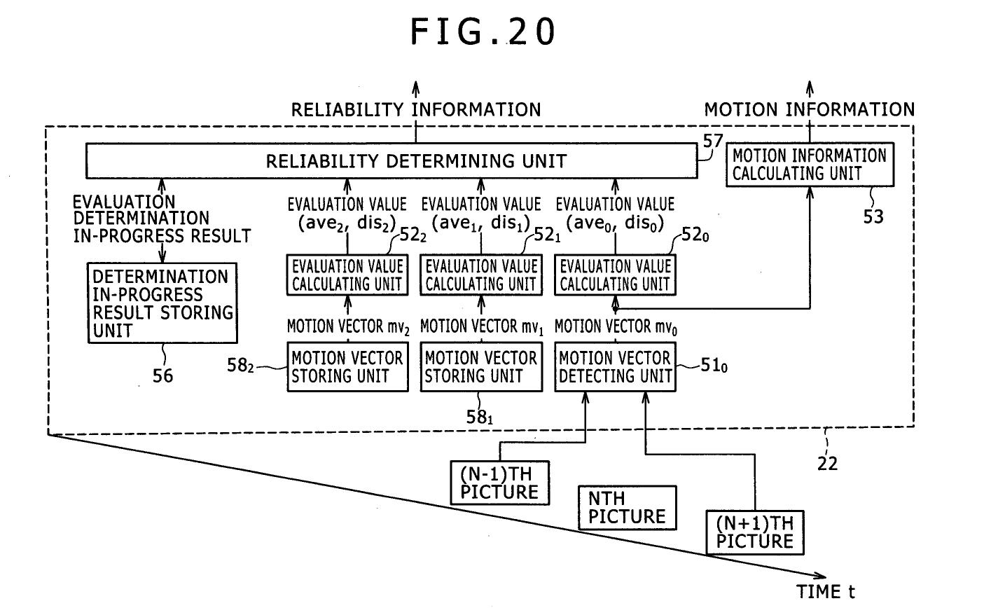

The motion estimating means can include one motion vector detecting means (for example a motion vector detecting unit 51₀ in FIG. 20) for detecting a motion vector of a pixel of a picture of interest, and a plurality of motion vector storing means (for example motion vector storing units 58₁ and 58₂ in FIG. 20) for storing detected motion vectors of pixels of a plurality of pictures (for example an (N−1)th picture and an (N−2)th picture) that have been a picture of interest in a past. The motion estimating means can further include motion information calculating means (for example a motion information calculating unit 53 in FIG. 20) for obtaining motion information of a pixel of interest using a motion vector of the pixel of interest and a motion vector of a pixel in vicinity of the pixel of interest, the motion vectors being detected by the motion vector detecting means,and a plurality of evaluation value calculating means (for example evaluation value calculating units 52₀ to 52₂ in FIG. 20) for obtaining evaluation values for evaluating the motion information of the pixel of interest, using the detected motion vectors of the picture of interest and the plurality of pictures. The motion estimating means can still further include determination in-progress result storing means (for example a determination in-progress result storing unit 56 in FIG. 20) for storing a determination in-progress result, which is an in-progress result of reliability determination that determines reliability of motion information. The motion estimating means can still further include reliability determining means (for example a reliability determining unit 57 in FIG. 20) for making reliability determination that determines reliability of the motion information of the pixel of interest using the evaluation values obtained by the plurality of evaluation value calculating means and the determination in-progress result of the past reliability determination, the determination in-progress result of the past reliability determination being stored by the determination in-progress result storing means, and making the determination in-progress result storing means store a determination in-progress result of the reliability determination.

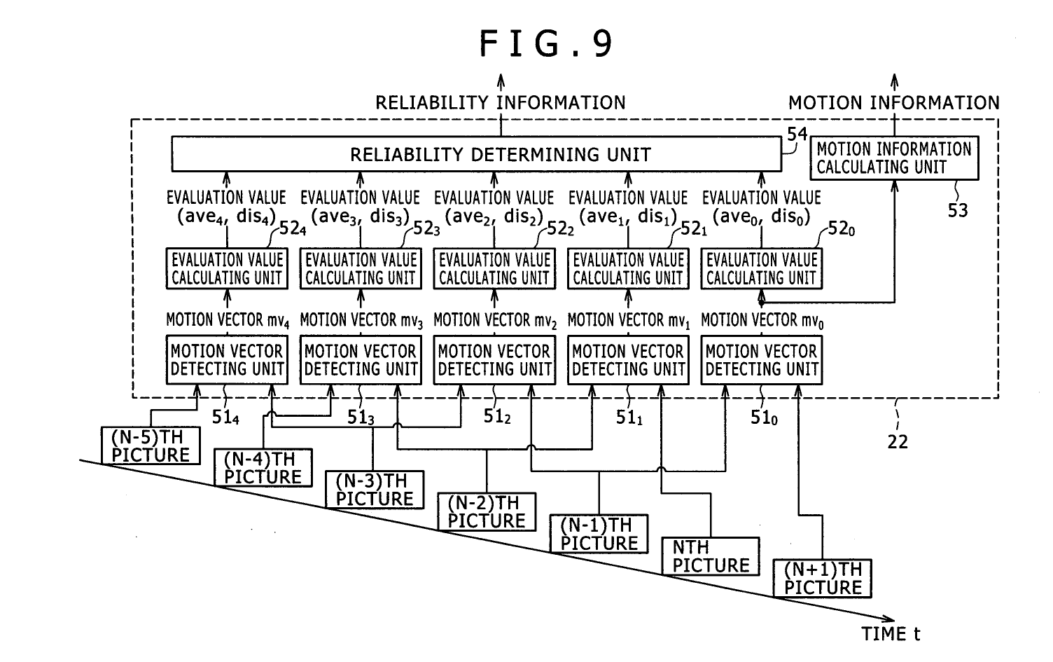

The motion estimating means can include a plurality of motion vector detecting means (for example motion vector detecting units 51₀ to 51₄ in FIG. 9) for detecting a motion vector of a pixel of a plurality of pictures (for example an Nth to an (N−4)th picture in FIG. 9), the plurality of pictures being a picture of interest and one or more other pictures adjacent to the picture of interest. The motion estimating means can further include motion information calculating means (for example a motion information calculating unit 53 in FIG. 9) for obtaining motion information of a pixel of interest using a motion vector of the pixel of interest and a motion vector of a pixel in vicinity of the pixel of interest, the motion vectors being detected by the motion vector detecting means for the picture of interest among the plurality of motion vector detecting means. The motion estimating means can still further include a plurality of evaluation value calculating means (for example evaluation value calculating units 52₀ to 52₄ in FIG. 9) for obtaining evaluation values for evaluating the motion information of the pixel of interest, using motion vectors detected by the plurality of motion vector detecting means, and reliability determining means (for example a reliability determining unit 54 in FIG. 9) for determining reliability of the motion information of the pixel of interest using the evaluation values obtained by the plurality of evaluation value calculating means.

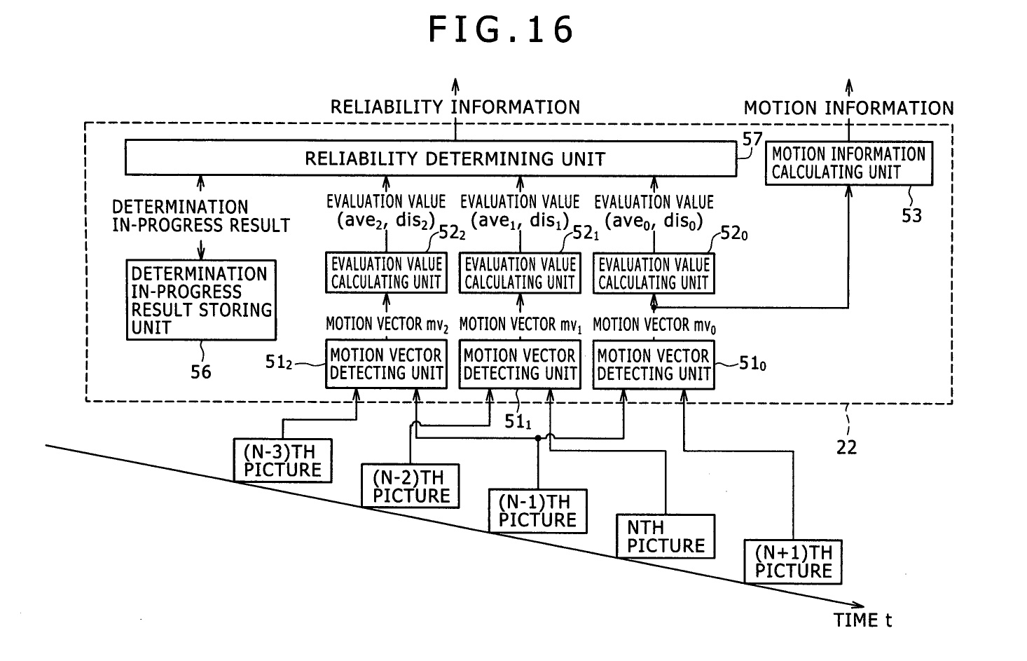

The motion estimating means can include a plurality of motion vector detecting means (for example motion vector detecting units 51₀ to 51₂ in FIG. 16) for detecting a motion vector of a pixel of a plurality of pictures (for example an Nth to an (N−2)th picture in FIG. 16), the plurality of pictures being a picture of interest and one or more other pictures adjacent to the picture of interest The motion estimating means can further include motion information calculating means (for example a motion information calculating unit 53 in FIG. 16) for obtaining motion information of a pixel of interest using a motion vector of the pixel of interest and a motion vector of a pixel in vicinity of the pixel of interest, the motion vectors being detected by the motion vector detecting means for the picture of interest among the plurality of motion vector detecting means The motion estimating means can still further include a plurality of evaluation value calculating means (for example evaluation value calculating units 52₀ to 52₂ in FIG. 16) for obtaining evaluation values for evaluating the motion information of the pixel of interest, using motion vectors detected by the plurality of motion vector detecting means, and determination in-progress result storing means (for example a determination in-progress result storing unit 56 in FIG. 16) for storing a determination in-progress result, which is an in-progress result of reliability determination that determines reliability of motion information. The motion estimating means can still further include reliability determining means (for example a reliability determining unit 57 in FIG. 16) for making reliability determination that determines reliability of the motion information of the pixel of interest using the evaluation values obtained by the plurality of evaluation value calculating means and the determination in-progress result of the past reliability determination, the determination in-progress result of the past reliability determination being stored by the determination in-progress result storing means, and making the determination in-progress result storing means store a determination in-progress result of the reliability determination.

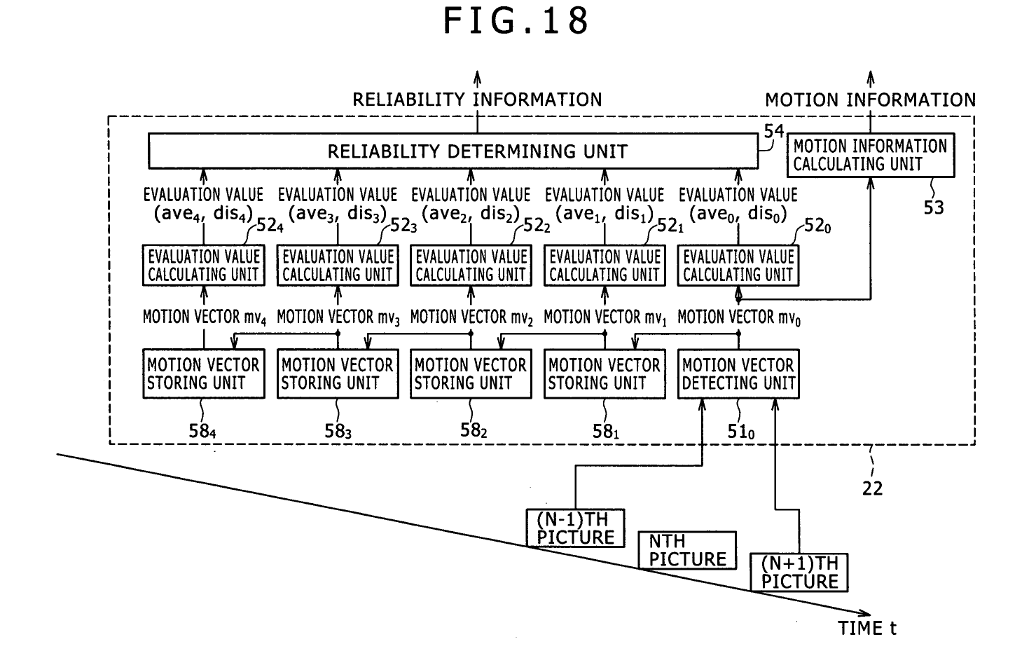

The motion estimating means can include one motion vector detecting means (for example a motion vector detecting unit 51₀ in FIG. 18) for detecting a motion vector of a pixel of a picture of interest, and a plurality of motion vector storing means (for example motion vector storing units 58₁ to 58₄ in FIG. 18) for storing detected motion vectors of pixels of a plurality of pictures (for example an (N−1)th to an (N−4)th picture) that have been a picture of interest in a past. the motion estimating means can still further include motion information calculating means (for example a motion information calculating unit 53 in FIG. 18) for obtaining motion information of a pixel of interest using a motion vector of the pixel of interest and a motion vector of a pixel in vicinity of the pixel of interest, the motion vectors being detected by the motion vector detecting means, and a plurality of evaluation value calculating means (for example evaluation value calculating units 52₀ to 52₄ in FIG. 18) for obtaining evaluation values for evaluating the motion information of the pixel of interest, using the detected motion vectors of the picture of interest and the plurality of pictures. The motion estimating means can still further include reliability determining means (for example a reliability determining unit 54 in FIG. 18) for determining reliability of the motion information of the pixel of interest using the evaluation values obtained by the plurality of evaluation value calculating means.

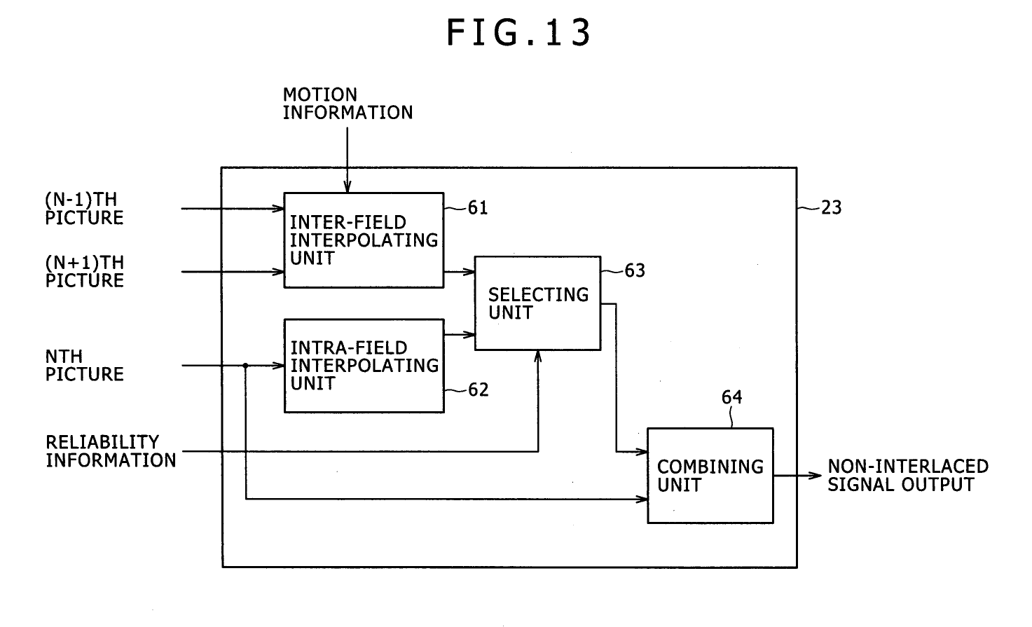

The image processing device according to the above-described embodiment can further include progressive image generating means (for example a progressive image generating unit 23 in FIG. 13) for generating a progressive image from an interlaced image, the progressive image generating means including first interpolating means (for example an intra-field interpolating unit 62 in FIG. 13) for obtaining a first interpolation value for the pixel of interest using a pixel value of another pixel of the picture of interest. The progressive image generating means further including second interpolating means (for example an inter-field interpolating unit 61 in FIG. 13) for obtaining a second interpolation value for the pixel of interest using a pixel value of a pixel of a picture adjacent to the picture of interest and the motion information of the pixel of interest. The progressive image generating means still further including and selecting means (for example a selecting unit 63 in FIG. 13) for selecting the first interpolation value and outputting the first interpolation value as pixel value of the pixel of interest when the reliability information indicates that the motion information is unreliable, and selecting the second interpolation value and outputting the second interpolation value as pixel value of the pixel of interest when the reliability information indicates that the motion information is reliable.

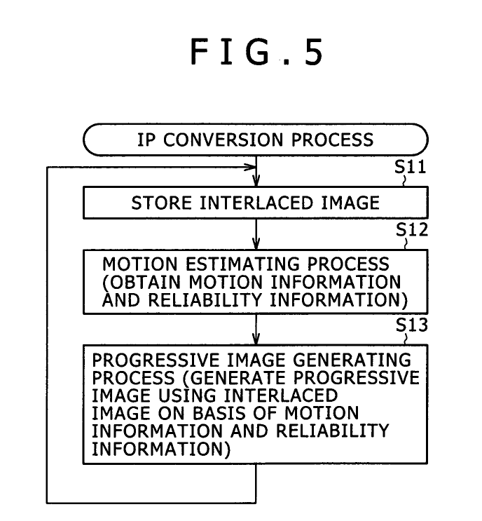

An image processing method according to an embodiment of the present invention is an image processing method of an image processing device for obtaining motion information indicating a motion of an image, the image processing method including a step (for example step S12 in FIG. 5) of obtaining motion information of a pixel of interest to which attention is directed among pixels of a picture of interest to which attention is directed, using a motion vector of the pixel of interest and a motion vector of a pixel in vicinity of the pixel of interest, and outputting the motion information of the pixel of interest, and obtaining an evaluation value for evaluating the motion information of the pixel of interest using motion vectors of a plurality of pixels of the picture of interest. The image processing method further including a step of obtaining an evaluation value for evaluating the motion information of the pixel of interest using motion vectors of a plurality of pixels of another picture adjacent to the picture of interest, determining reliability of the motion information of the pixel of interest using the evaluation values, and outputting reliability information indicating the reliability.

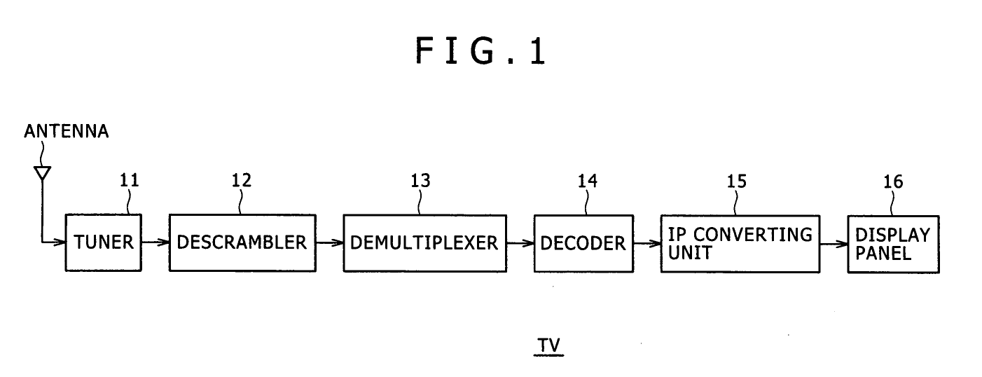

A display device according to an embodiment of the present invention is a display device (for example a TV in FIG. 1) for displaying an image of a broadcast program, the display device including receiving means (for example a tuner 11 in FIG. 1) for receiving the broadcast program. The display device further including motion estimating means (for example a motion estimating unit 22 in FIG. 2) for obtaining motion information of a pixel of interest to which attention is directed among pixels of a picture of interest to which attention is directed among pictures constituting the image of the broadcast program, using a motion vector of the pixel of interest and a motion vector of a pixel in vicinity of the pixel of interest, and outputting the motion information of the pixel of interest. The display device further including motion estimating means for obtaining an evaluation value for evaluating the motion information of the pixel of interest using motion vectors of a plurality of pixels of the picture of interest, obtaining an evaluation value for evaluating the motion information of the pixel of interest using motion vectors of a plurality of pixels of another picture adjacent to the picture of interest, determining reliability of the motion information of the pixel of interest using the evaluation values, and outputting reliability information indicating the reliability. The display device still further including progressive image generating means (for example a progressive image generating unit 23 in FIG. 2) for obtaining a first interpolation value for the pixel of interest using a pixel value of another pixel of the picture of interest and obtaining a second interpolation value for the pixel of interest using a pixel value of a pixel of a picture adjacent to the picture of interest and the motion information of the pixel of interest, and selecting the first interpolation value and outputting the first interpolation value as pixel value of the pixel of interest when the reliability information indicates that the motion information is unreliable, and selecting the second interpolation value and outputting the second interpolation value as pixel value of the pixel of interest when the reliability information indicates that the motion information is reliable, whereby a progressive image is generated from an interlaced image. The display device still further including displaying means (for example a display panel 16 in FIG. 1) for displaying the progressive image.

Preferred embodiments of the present invention will hereinafter be described with reference to the drawings.

FIG. 1 is a block diagram showing an example of configuration of an embodiment of a TV (television receiver) as a display device to which the present invention is applied.

A tuner 11 is for example supplied with a broadcast signal of terrestrial digital broadcasting from an antenna.

The tuner 11 extracts for example a transport stream as a signal in a predetermined frequency band from the broadcast signal supplied thereto. The tuner 11 then supplies the transport stream to a descrambler 12.

The descrambler 12 descrambles the transport stream from the tuner 11. The descrambler 12 then supplies the transport stream to a demultiplexer 13.

The demultiplexer 13 separates TS (Transport Stream) packets including image data and audio data of a predetermined broadcast program from the transport stream from the descrambler 12, and then outputs the TS packets.

The TS packets of the audio data which packets are output from the demultiplexer 13 are decoded by a decoder not shown in the figure. Then, the audio data obtained as a result of the decoding is supplied to a speaker not shown in the figure, and corresponding sound is output from the speaker.

In addition, the TS packets of the image data which packets are output from the demultiplexer 13 are supplied to a decoder 14. The decoder 14 decodes the TS packets from the demultiplexer 13. The decoder 14 then supplies the image data of an interlaced image obtained as a result of the decoding to an IP converting unit 15.

The IP converting unit 15 is an image processing device that subjects the interlaced image from the decoder 14 to image processing. The IP converting unit 15 converts the interlaced image (the image data of the interlaced image) from the decoder 14 to a progressive image by IP conversion. The progressive image obtained by the IP conversion in the IP converting unit 15 is supplied to a display panel 16.

The display panel 16 is for example formed by a liquid crystal panel, an organic EL (Electro Luminescence) panel or the like. The display panel 16 displays the progressive image from the IP converting unit 15.

FIG. 2 shows an example of configuration of the IP converting unit 15 in FIG. 1.

The IP converting unit 15 includes a memory unit 21, a motion estimating unit 22, and a progressive image generating unit 23.

The memory unit 21 temporarily stores the interlaced image supplied from the decoder 14 in picture (field) units. The memory unit 21 supplies the interlaced image to the motion estimating unit 22 and the progressive image generating unit 23 as required.

The motion estimating unit 22 sequentially sets a picture (a picture of the interlaced image) stored in the memory unit 21 as a picture of interest to which attention is directed. The motion estimating unit 22 obtains motion information of a pixel of interest to which attention is directed among pixels of the picture of interest, using a motion vector of the pixel of interest and a motion vector of a pixel in the vicinity of the pixel of interest. The motion estimating unit 22 then outputs the motion information of the pixel of interest.

Further, the motion estimating unit 22 obtains an evaluation value for evaluating the motion information of the pixel of interest using motion vectors of a plurality of pixels of the picture of interest, and obtains an evaluation value for evaluating the motion information of the pixel of interest using motion vectors of a plurality of pixels of another picture adjacent to the picture of interest. Then, the motion estimating unit 22 determines reliability of the motion information of the pixel of interest using the evaluation values, and outputs reliability information indicating the reliability.

The motion information and the reliability information output by the motion estimating unit 22 are supplied to the progressive image generating unit 23.

The progressive image generating unit 23 generates a progressive image from the interlaced image stored in the memory unit 21 using the motion information and the reliability information from the motion estimating unit 22. The progressive image generating unit 23 then outputs the progressive image.

Specifically, the progressive image generating unit 23 obtains an intra-field interpolation value (first interpolation value) by performing intra-field interpolation using a pixel value of another pixel of the picture of interest, and obtains an inter-field interpolation value (second interpolation value) by performing inter-field interpolation using a pixel value of a pixel of a picture adjacent to the picture of interest and the motion information of the pixel of interest from the motion estimating unit 22.

Then, when the reliability information from the motion estimating unit 22 indicates that the motion information of the pixel of interest is unreliable, the progressive image generating unit 23 selects the intra-field interpolation value as pixel value of the pixel of interest.

When the reliability information from the motion estimating unit 22 indicates that the motion information of the pixel of interest is reliable, on the other hand, the progressive image generating unit 23 selects the inter-field interpolation value as pixel value of the pixel of interest.

The progressive image generating unit 23 sets pixels that do not have a pixel value in the picture of interest stored in the memory unit 21 as interpolation object pixels, sequentially sets the interpolation object pixels as a pixel of interest, and determines a pixel value of the pixel of interest, that is, the interpolation object pixel.

The progressive image generating unit 23 then generates a progressive image from pixels that have a pixel value in the picture of interest and the interpolation object pixels whose pixel values are determined.

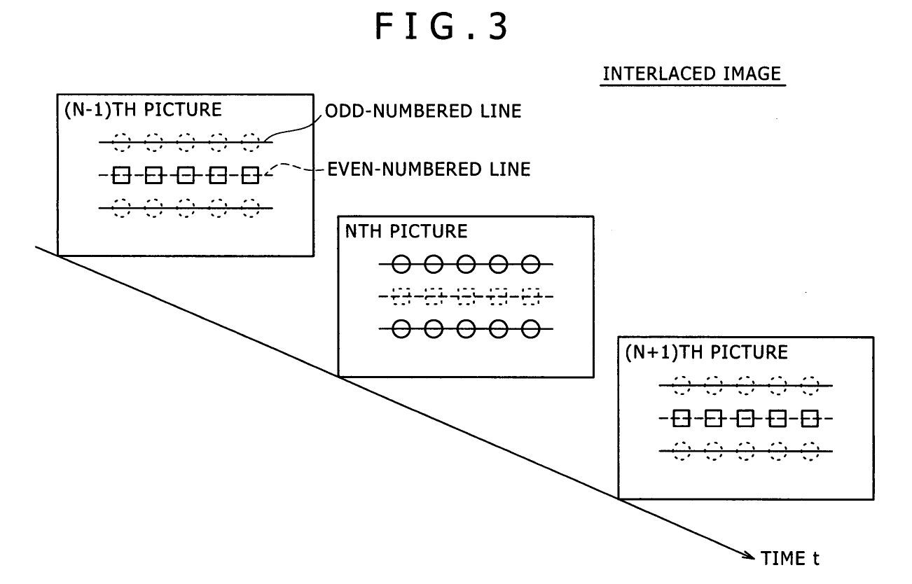

FIG. 3 shows an interlaced image.

Pictures of the interlaced image include pictures that have only odd-numbered lines (pixel values of the odd-numbered lines) and do not have even-numbered lines (pixel values of the even-numbered lines) and pictures that have only even-numbered lines and do not have odd-numbered lines. The pictures that have only odd-numbered lines (odd-numbered fields) and the pictures that have only even-numbered lines (even-numbered fields) are arranged alternately.

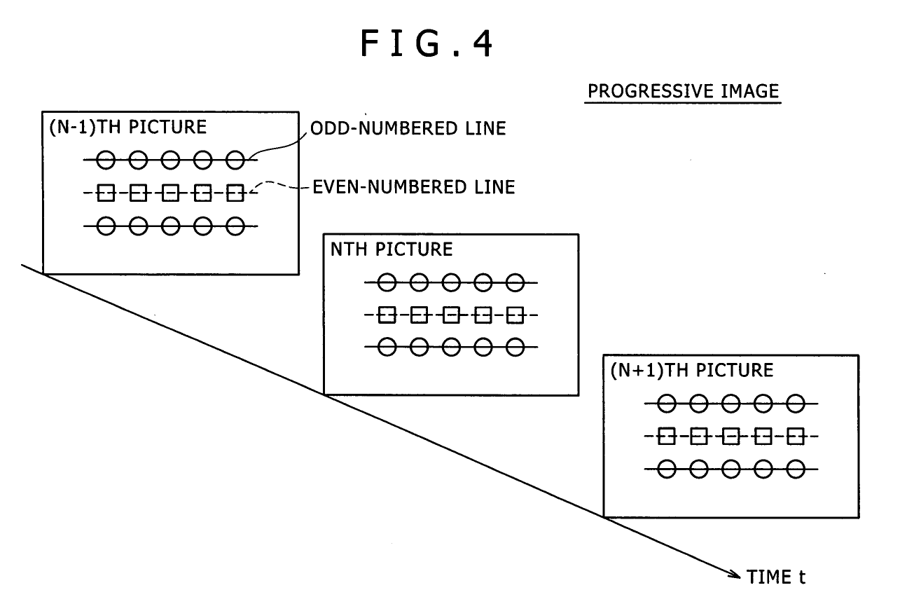

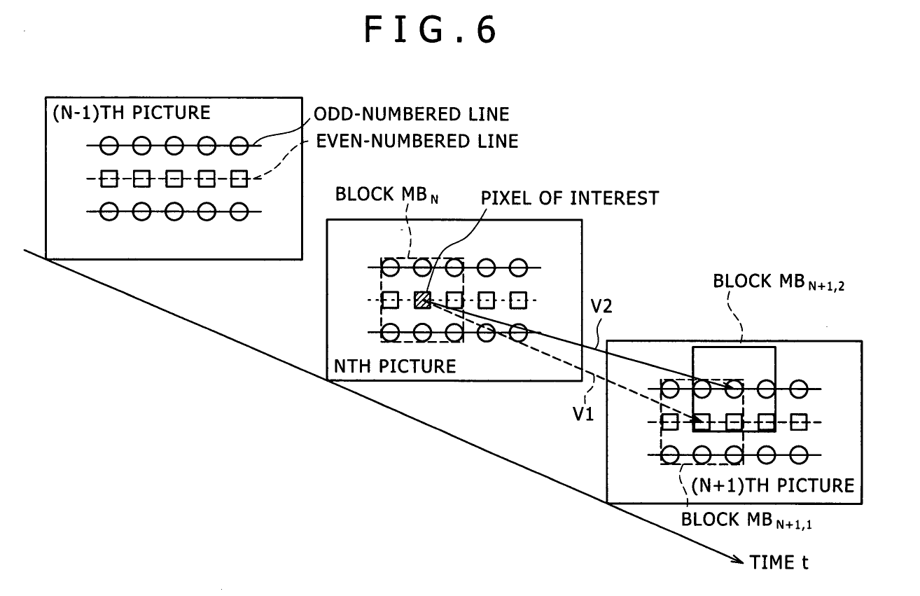

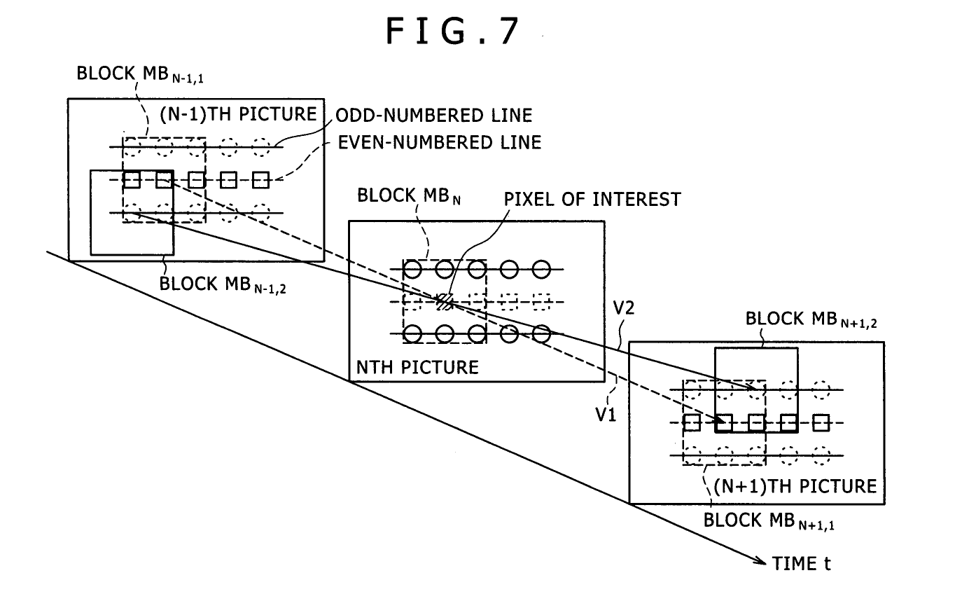

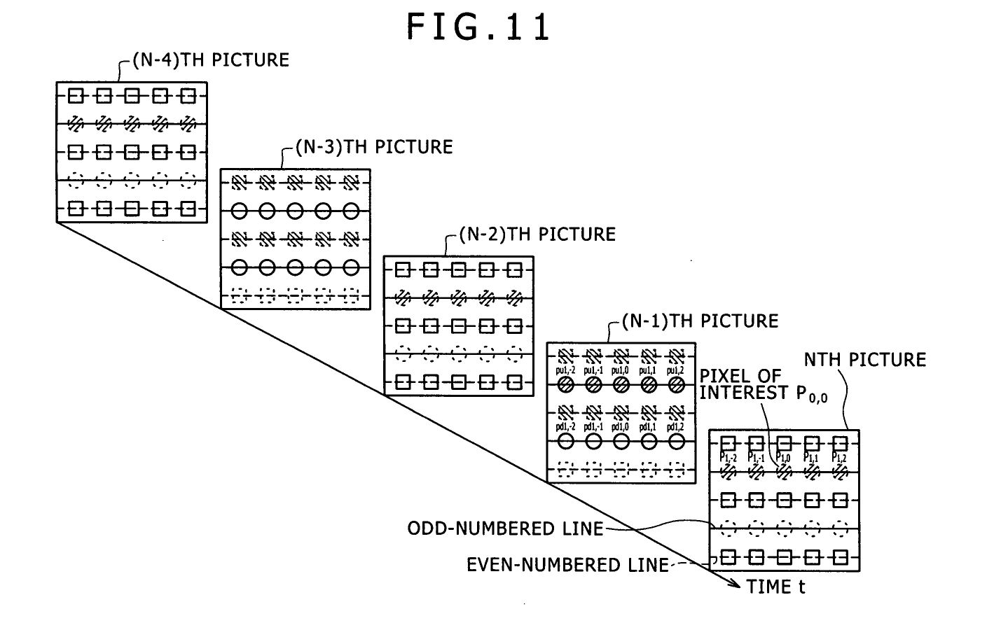

In FIG. 3 (as is the case in FIG. 4, FIG. 6, FIG. 7, and FIG. 11 to be described later), odd-numbered lines are represented by a solid line, and even-numbered lines are represented by a dotted line.

Further, in FIG. 3 (as is the case in FIG. 4, FIG. 6, FIG. 7, and FIG. 11 to be described later), pixels in the odd-numbered lines are represented by a circle, and pixels in the even-numbered lines are represented by a rectangle (square).

Incidentally, of the circles representing the pixels in the odd-numbered lines, circles representing pixels that have a pixel value are formed by a solid line, and circles representing pixels that do not have a pixel value are formed by a dotted line. Similarly, of the rectangles representing the pixels in the even-numbered lines, rectangles representing pixels that have a pixel value are formed by a solid line, and rectangles representing pixels that do not have a pixel value are formed by a dotted line.

In FIG. 3, an (N−1)th picture and an (N+1)th picture are even-numbered fields that have only even-numbered lines, and an Nth picture is an odd-numbered field that has only odd-numbered lines.

In this case, the Nth picture is an Nth picture from a start of the image of a broadcast program, for example. Thus, the (N−1)th picture is a past picture (hereinafter referred to also as a preceding picture) preceding the Nth picture by one picture, and the (N+1)th picture is a future picture (hereinafter referred to also as a succeeding picture) succeeding the Nth picture by one picture.

FIG. 4 shows a progressive image.

Pictures of the progressive image have both of odd-numbered lines and even-numbered lines.

The IP converting unit 15 in FIG. 2 performs IP conversion to convert . . . , the (N−1)th picture, the Nth picture, the (N+1)th picture, . . . of the interlaced image shown in FIG. 3 into . . . , the (N−1)th picture, the Nth picture, the (N+1)th picture, . . . of the progressive image shown in FIG. 4.

FIG. 5 is a flowchart of assistance in explaining a process of the IP conversion (an IP conversion process) performed by the IP converting unit 15 in FIG. 2.

The IP converting unit 15 waits to be supplied with a new picture of an interlaced image from the decoder 14 (FIG. 1). The memory unit 21 in step S11 temporarily stores a picture of an interlaced image from the decoder 14. The process then proceeds to step S12.

In step S12, the motion estimating unit 22 performs a motion estimating process that sets a predetermined picture of pictures (of the interlaced image) stored in the memory unit 21 as a picture of interest and which obtains motion information of interpolation object pixels (pixels that do not have a pixel value) of the picture of interest and reliability information indicating reliability of the motion information.

The motion estimating unit 22 then supplies the motion information and the reliability information obtained by the motion estimating process to the progressive image generating unit 23. The process proceeds from step S12 to step S13.

In step S13, the progressive image generating unit 23 performs a progressive image generating process that generates the progressive image of the picture of interest using the interlaced image of the picture of interest stored in the memory unit 21 on the basis of the motion information and the reliability information from the motion estimating unit 22. The progressive image generating unit 23 then supplies the progressive image obtained as a result of the progressive image generating process to the display panel 16 (FIG. 1).

The process then returns from step S13 to step S11 to repeat the same process from step S11 on down.

Description will next be made of the IP conversion process performed by the IP converting unit 15. Prior to the description of the IP conversion process, however, description will be made of a method of detecting a motion vector by block matching.

A method of detecting a motion vector of a progressive image will first be described with reference to FIG. 6.

Incidentally, in this case, suppose that a vector facing in a future direction (a vector having a starting point on a past side and having an ending point on a future side), for example, is detected as a motion vector.

FIG. 6 shows three consecutive pictures, that is, an (N−1)th picture, an Nth picture, and an (N+1)th picture of a progressive image.

When the Nth picture of the progressive image is set as a picture of interest and a certain pixel of the picture of interest is set as a pixel of interest to detect the motion vector of the pixel of interest, the motion vector is detected using the picture of interest and the (N+1)th picture as a succeeding picture succeeding the picture of interest by one picture.

Specifically, a macroblock (hereinafter referred to simply as a block as appropriate) of a predetermined size which macroblock has the pixel of interest as a center thereof is set in the Nth picture as the picture of interest. In FIG. 6, a block MB_{N} of 3×3 pixels, that is, 3 pixel rows and 3 pixel columns which block has the pixel of interest as a center thereof is set.

Further, a plurality of vectors having the pixel of interest as a starting point and having the position of a pixel of the (N+1)th picture as the succeeding picture as an ending point are set as candidate vectors, which are candidates for the motion vector. One candidate vector v₁ of the plurality of candidate vectors is selected as a candidate vector of interest.

Then, a block of the same size as that of the block MB_{N}, that is, a block MB_{N+1, 1} of 3×3 pixels or 3 pixel rows and 3 pixel columns is set as a corresponding block corresponding to the block MB_{N} in the (N+1)th picture with a pixel at the position of an ending point of the candidate vector v₁ of interest as a center of the corresponding block MB_{N+1, 1}. A motion error, which is for example a sum total of differences (absolute values of the differences) between the pixel values of respective pixels in the block MB_{N} and the pixel values of pixels at same positions in the corresponding block MB_{N+1, 1,} is obtained.

Motion errors are similarly obtained for the other candidate vectors. When motion errors have been obtained for all the candidate vectors, a candidate vector giving a minimum motion error is detected as the motion vector of the pixel of interest.

Hence, supposing that there are for example two vectors v₁ and v₂ as candidate vectors, a sum total of differences between the pixel values of a corresponding block MB_{N+1, 1} having a pixel at the position of an ending point of the candidate vector v₁ as a center thereof in the (N+1)th picture and the pixel values of the block MB_{N} having the pixel of interest as a center thereof in the Nth picture is obtained as a motion error of the candidate vector v₁.

Further, a sum total of differences between the pixel values of a corresponding block MB_{N+1, 2} having a pixel at the position of an ending point of the candidate vector v₂ as a center thereof in the (N+1)th picture and the pixel values of the block MB_{N} having the pixel of interest as a center thereof in the Nth picture is obtained as a motion error of the candidate vector v₂.

When, of the motion error of the candidate vector v₁ and the motion error of the candidate vector v₂, the motion error of the candidate vector v₁ is smaller, the candidate vector v₁ is detected as the motion vector of the pixel of interest. When the motion error of the candidate vector v₂ is smaller, on the other hand, the candidate vector v₂ is detected as the motion vector of the pixel of interest.

As described above, the picture of interest and the succeeding picture (or a preceding picture) are necessary to detect the motion vectors of the progressive image.

A method of detecting a motion vector of an interlaced image will next be described with reference to FIG. 7.

FIG. 7 shows three consecutive pictures, that is, an (N−1)th picture, an Nth picture, and an (N+1)th picture of an interlaced image.

In the case of the interlaced image, as in the case of the progressive image, motion errors are obtained for all of a plurality of candidate vectors, and a candidate vector giving a minimum motion error is detected as the motion vector of a pixel of interest.

In the interlaced image, however, as described with reference to FIG. 3, pictures having only odd-numbered lines (odd-numbered fields) and pictures having only even-numbered lines (even-numbered fields) are arranged alternately.

Thus, the position of pixels having a pixel value differs between the Nth picture as a picture of interest and the (N+1)th picture as a succeeding picture.

Accordingly, in the interlaced image, a motion vector is detected using the (N+1)th picture as the succeeding picture and the (N−1)th picture as a preceding picture preceding the picture of interest by one picture rather than being detected using the Nth picture as the picture of interest and the (N+1)th picture as the succeeding picture as in the progressive image.

Specifically, a plurality of vectors passing through a pixel of interest and having the position of a pixel of the (N−1)th picture as the preceding picture as a starting point and having the position of a pixel of the (N+1)th picture as the succeeding picture as an ending point are set as candidate vectors, which are candidates for the motion vector. One candidate vector v₁ of the plurality of candidate vectors is selected as a candidate vector of interest.

Then, two blocks, that is, a block MB_{N-1, 1} of the same size as that of the block MB_{N} of the pixel of interest, the block MB_{N-1, 1} having a pixel at the position of a starting point of the candidate vector v₁ of interest as a center thereof in the (N−1)th picture, and a block MB_{N+1, 1} of the same size as that of the block MB_{N} of the pixel of interest, the block MB_{N+1, 1} having a pixel at the position of an ending point of the candidate vector v₁ of interest as a center thereof in the (N+1)th picture, are set as corresponding blocks corresponding to the block MB_{N} of the pixel of interest. A sum total of differences between the pixel values of pixels at same positions in the two corresponding blocks MB_{N-1, 1} and MB_{N+1, 1,} for example, is obtained as a motion error of the candidate vector v₁ of interest.

Motion errors are similarly obtained for the other candidate vectors. When motion errors have been obtained for all the candidate vectors, a candidate vector giving a minimum motion error is detected as the motion vector of the pixel of interest.

Hence, supposing that there are for example two vectors v₁ and v₂ passing through the pixel of interest as candidate vectors, a sum total of differences between the pixel values of a corresponding block MB_{N-1, 1} in the (N−1)th picture, the corresponding block MB_{N-1, 1} having a pixel at the position of a starting point of the candidate vector v₁ as a center thereof, and the pixel values of a corresponding block MB_{N+1, 1} in the (N+1)th picture, the corresponding block MB_{N+1, 1} having a pixel at the position of an ending point of the candidate vector v₁ as a center thereof, is obtained as a motion error of the candidate vector v₁.

Further, a sum total of differences between the pixel values of a corresponding block MB_{N-1, 2} in the (N−1)th picture, the corresponding block MB_{N-1, 2} having a pixel at the position of a starting point of the candidate vector v₂ as a center thereof, and the pixel values of a corresponding block MB_{N+1, 2} in the (N+1)th picture, the corresponding block MB_{N+1, 2} having a pixel at the position of an ending point of the candidate vector v₂ as a center thereof, is obtained as a motion error of the candidate vector v₂.

When, of the motion error of the candidate vector v₁ and the motion error of the candidate vector v₂, the motion error of the candidate vector v₁ is smaller, the candidate vector v₁ is detected as the motion vector of the pixel of interest. When the motion error of the candidate vector v₂ is smaller, on the other hand, the candidate vector v₂ is detected as the motion vector of the pixel of interest.

As described above, the preceding picture preceding the picture of interest and the succeeding picture succeeding the picture of interest are necessary to detect the motion vectors of the interlaced image.

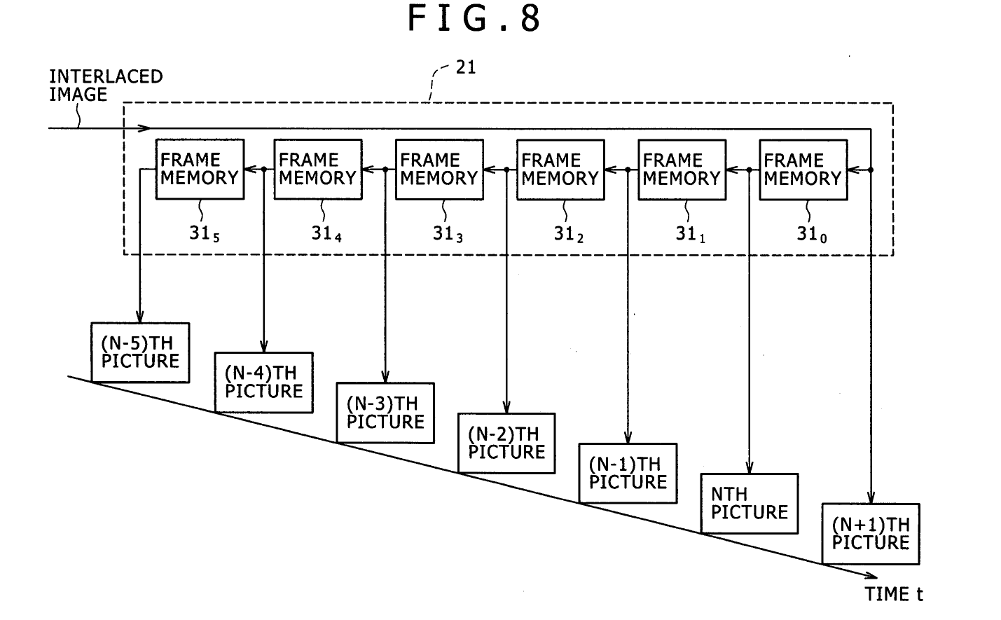

FIG. 8 shows an example of configuration of the memory unit 21 in FIG. 2.

The memory unit 21 in FIG. 8 is formed by connecting six frame (field) memories 31₀, 31₁, 31₂, 31₃, 31₄, and 31₅ in series with each other. The memory 31ᵢ (i=0, 1, . . . , 5) has a storage capacity to store at least pixel values of one field.

The memory unit 21 is supplied with a picture (field) of an interlaced image from the decoder 14 (FIG. 1).

The picture supplied from the decoder 14 to the memory unit 21 is supplied to the motion estimating unit 22 and the progressive image generating unit 23 (FIG. 2), and supplied to the frame memory 31₀.

The frame memory 31₀ stores the picture supplied from the decoder 14 to the memory unit 21 until a next picture (succeeding picture) is supplied, that is, delays the picture by the time of one picture. The frame memory 31₀ then supplies the picture to the frame memory 31₁ in a succeeding stage, and supplies the picture to the motion estimating unit 22 and the progressive image generating unit 23 (FIG. 2).

As with the frame memory 31₀, the frame memory 31₁ stores the picture supplied from the frame memory 31₀ in the preceding stage, and thereby delays the picture by the time of one picture. The frame memory 31₁ then supplies the picture to the frame memory 31₂ in a succeeding stage, and supplies the picture to the motion estimating unit 22 and the progressive image generating unit 23.

As with the frame memory 31₀, the frame memory 31₂ stores the picture supplied from the frame memory 31₁ in the preceding stage, and thereby delays the picture by the time of one picture. The frame memory 31₂ then supplies the picture to the frame memory 31₃ in a succeeding stage, and supplies the picture to the motion estimating unit 22.

As with the frame memory 31₀, the frame memory 31₃ stores the picture supplied from the frame memory 31₂ in the preceding stage, and thereby delays the picture by the time of one picture. The frame memory 31₃ then supplies the picture to the frame memory 31₄ in a succeeding stage, and supplies the picture to the motion estimating unit 22.

As with the frame memory 31₀, the frame memory 31₄ stores the picture supplied from the frame memory 31₃ in the preceding stage, and thereby delays the picture by the time of one picture. The frame memory 31₄ then supplies the picture to the frame memory 31₅ in a succeeding stage, and supplies the picture to the motion estimating unit 22.

As with the frame memory 31₀, the frame memory 31₅ stores the picture supplied from the frame memory 31₄ in the preceding stage, and thereby delays the picture by the time of one picture. The frame memory 31₅ then supplies the picture to the motion estimating unit 22.

Thus, supposing that the picture supplied from the decoder 14 to the memory unit 21 at certain time t is an (N+1)th picture, the memory unit 21 at this time stores an Nth picture, an (N−1)th picture, an (N−2)th picture, an (N−3)th picture, an (N−4)th picture, and an (N−5)th picture in the frame memories 31₀ to 31₅, respectively. The memory unit 21 therefore outputs seven consecutive pictures, that is, the (N+1)th to (N−5)th pictures.

As described above, the motion estimating unit 22 (FIG. 2) is supplied with all of the seven pictures output by the memory unit 21, that is, the (N+1)th to (N−5)th pictures. The progressive image generating unit 23 (FIG. 2) is supplied with three pictures, that is, the (N+1)th to (N−1)th pictures of the seven pictures output by the memory unit 21, that is, the (N+1)th to (N−5)th pictures.

The motion estimating unit 22 and the progressive image generating unit 23 perform a process with the picture stored in the frame memory 31₀ as a picture of interest, that is, with the Nth picture as a picture of interest when the Nth to (N−5)th pictures are stored in the frame memories 31₀ to 31₅, respectively.

FIG. 9 is a block diagram showing a first example of configuration of the motion estimating unit 22 in FIG. 2.

The motion estimating unit 22 in FIG. 9 includes five motion vector detecting units 51₀, 51₁, 51₂, 51₃, and 51₄, five evaluation value calculating units 52₀, 52₁, 52₂, 52₃, and 52₄, a motion information calculating unit 53, and a reliability determining unit 54.

The motion vector detecting units 51₀ to 51₄ detect the motion vectors of pixels of a plurality of pictures that are the picture of interest and one or more other pictures adjacent to the picture of interest. The motion vector detecting units 51₀ to 51₄ then supply the motion vectors to the evaluation value calculating units 52₀ to 52₄, respectively.

Specifically, for example, supposing that the Nth picture is stored in the frame memory 31₀ of the memory unit 21 (FIG. 8), with the Nth picture stored in the frame memory 31₀ as the picture of interest, the motion vector detecting units 51₀ to 51₄ detect the motion vectors of pixels of the five Nth to (N−4)th pictures, that is, the Nth picture as the picture of interest and the (N−1)th to (N−4)th pictures stored in the frame memories 31₁ to 31₄ as one or more other pictures adjacent to the picture of interest. The motion vector detecting units 51₀ to 51₄ then supply the motion vectors to the evaluation value calculating units 52₀ to 52₂, respectively.

Specifically, the motion vector detecting unit 51₀ is supplied from the memory unit 21 with the newest (N+1)th picture supplied from the decoder 14 (FIG. 1) to the memory unit 21 and the (N−1)th picture stored in the frame memory 31₁ (FIG. 8).

The motion vector detecting unit 51₀ detects the motion vector mv₀ of an interpolation object pixel of the Nth picture as the picture of interest as described with reference to FIG. 7 using the (N−1)th picture as the preceding picture preceding the Nth picture as the picture of interest and the (N+1)th picture as the succeeding picture succeeding the Nth picture as the picture of interest. The motion vector detecting unit 51₀ then supplies the motion vector mv₀ to the evaluation value calculating unit 52₀ and the motion information calculating unit 53.

The motion vector detecting unit 51₁ is supplied from the memory unit 21 with the Nth picture stored in the frame memory 31₀ (FIG. 8) and the (N−2)th picture stored in the frame memory 31₂.

The motion vector detecting unit 51₁ detects the motion vector mv₁ of an interpolation object pixel of the (N−1)th picture as described with reference to FIG. 7 using the (N−2)th picture as the preceding picture preceding the (N−1)th picture preceding the Nth picture as the picture of interest by one picture and the Nth picture as the succeeding picture succeeding the (N−1)th picture among the four consecutive (N−1)th to (N−4)th pictures adjacent to the picture of interest. The motion vector detecting unit 51₁ then supplies the motion vector mv₁ to the evaluation value calculating unit 52₁.

The motion vector detecting unit 51₂ is supplied from the memory unit 21 with the (N−1)th picture stored in the frame memory 31₁ (FIG. 8) and the (N−3)th picture stored in the frame memory 31₃.

The motion vector detecting unit 51₂ detects the motion vector mv₂ of an interpolation object pixel of the (N−2)th picture as described with reference to FIG. 7 using the (N−3)th picture as the preceding picture preceding the (N−2)th picture preceding the Nth picture as the picture of interest by two pictures and the (N−1)th picture as the succeeding picture succeeding the (N−2)th picture among the four consecutive (N−1)th to (N−4)th pictures adjacent to the picture of interest. The motion vector detecting unit 51₂ then supplies the motion vector mv₂ to the evaluation value calculating unit 52₂.

The motion vector detecting unit 51₃ is supplied from the memory unit 21 with the (N−2)th picture stored in the frame memory 31₂ (FIG. 8) and the (N−4)th picture stored in the frame memory 31₄.

The motion vector detecting unit 51₃ detects the motion vector mv₃ of an interpolation object pixel of the (N−3)th picture as described with reference to FIG. 7 using the (N−4)th picture as the preceding picture preceding the (N−3)th picture preceding the Nth picture as the picture of interest by three pictures and the (N−2)th picture as the succeeding picture succeeding the (N−3)th picture among the four consecutive (N−1)th to (N−4)th pictures adjacent to the picture of interest. The motion vector detecting unit 51₃ then supplies the motion vector mv₃ to the evaluation value calculating unit 52₃.

The motion vector detecting unit 51₄ is supplied from the memory unit 21 with the (N−3)th picture stored in the frame memory 31₃ (FIG. 8) and the (N−5)th picture stored in the frame memory 31₅.

The motion vector detecting unit 51₄ detects the motion vector mv₄ of an interpolation object pixel of the (N−4)th picture as described with reference to FIG. 7 using the (N−5)th picture as the preceding picture preceding the (N−4)th picture preceding the Nth picture as the picture of interest by four pictures and the (N−3)th picture as the succeeding picture succeeding the (N−4)th picture among the four consecutive (N−1)th to (N−4)th pictures adjacent to the picture of interest. The motion vector detecting unit 51₄ then supplies the motion vector mv₄ to the evaluation value calculating unit 52₄.

The evaluation value calculating unit 52ₖ (k=0, 1, . . . , 4) obtains an evaluation value for evaluating the motion information of a pixel of interest of the picture of interest using the motion vector mvₖ supplied from the motion vector detecting unit 51ₖ. The evaluation value calculating unit 52ₖ then supplies the evaluation value to the reliability determining unit 54.

The motion information calculating unit 53 obtains the motion information of the pixel of interest using the motion vector of the pixel of interest and the motion vector of a pixel in the vicinity of the pixel of interest, the motion vectors being supplied from the motion vector detecting unit 51₀ for the Nth picture as the picture of interest among the five motion vector detecting units 51₀ to 51₄. The motion information calculating unit 53 then supplies the motion information of the pixel of interest to the progressive image generating unit 23 (FIG. 2).

The reliability determining unit 54 determines reliability of the motion information of the pixel of interest, which motion information is obtained by the motion information calculating unit 53, using the evaluation values supplied from the evaluation value calculating units 52₀ to 52₄. The reliability determining unit 54 supplies reliability information indicating the reliability to the progressive image generating unit 23 (FIG. 2).

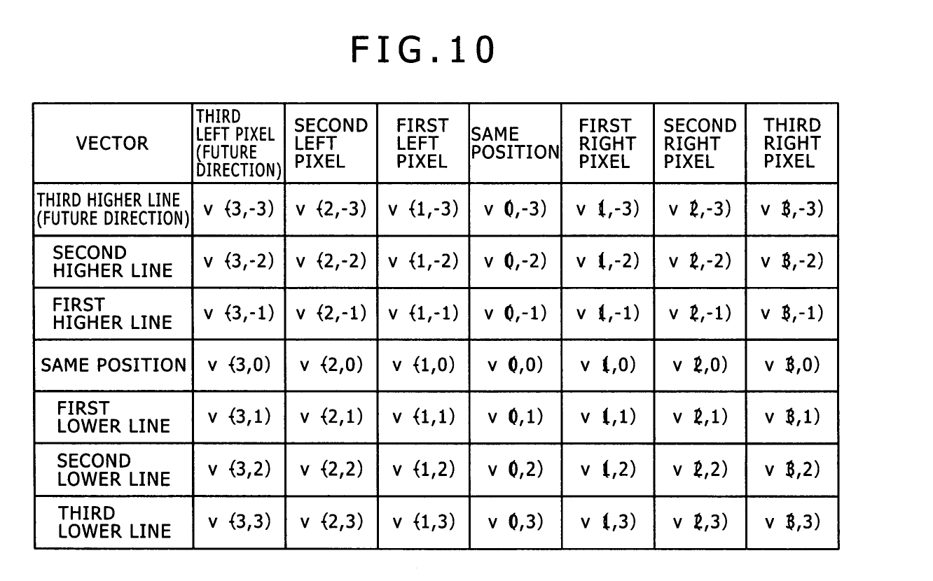

The process of the motion vector detecting unit 51ₖ in FIG. 9 will next be further described with reference to FIG. 10.

The motion vector detecting unit 51ₖ sets the (N−k)th picture preceding the picture of interest by k pictures as a picture whose motion vectors are to be detected (which picture will hereinafter be referred to as a detection object picture). The motion vector detecting unit 51ₖ detects the motion vector mvₖ of an interpolation object pixel of the detection object picture as described with reference to FIG. 7 using the (N−k−1)th picture as a preceding picture and the (N−k+1)th picture as a succeeding picture.

That is, as described with reference to FIG. 7, the motion vector detecting unit 51ₖ obtains motion errors for a plurality of candidate vectors, respectively, and detects a candidate vector giving a minimum motion error as a motion vector.

FIG. 10 shows an example of a plurality of candidate vectors.

The motion vector detecting unit 51ₖ detects a motion vector with 49 vectors v(−3, −3) to v(3, 3) shown in FIG. 10, for example, as candidate vectors.

A pixel whose motion vector is to be detected by the motion vector detecting unit 51ₖ among interpolation object pixels of the (N−k)th picture as the detection object picture will be referred to as a detection object pixel. An x-axis is taken in a left-to-right direction of the picture, and a y-axis is taken in a top-to-bottom direction of the picture.

In this case, in FIG. 10, a candidate vector v(x, y) is a vector that passes through the detection object pixel and which has, as an ending point, a position shifted from the position of the detection object pixel by (x, y) in the (N−k+1)th picture as the succeeding picture succeeding the detection object picture and has, as a starting point, a position shifted from the position of the detection object pixel by (−x, −y) in the (N−k−1)th picture as the preceding picture preceding the detection object picture.

The motion vector detecting unit 51ₖ sequentially sets the 49 candidate vectors v(x, y) in FIG. 10 as a candidate vector of interest for the detection object pixel of the (N−k)th picture as the detection object picture.

Further, the motion vector detecting unit 51ₖ sets a corresponding block of 3−3 pixels, or 3 pixel rows and 3 pixel columns, which block has a pixel at the position of a starting point of the candidate vector of interest as a center of the corresponding block in the (N−k−1)th picture as the preceding picture preceding the detection object picture and sets a corresponding block of 3×3 pixels, or 3 pixel rows and 3 pixel columns, which block has a pixel at the position of an ending point of the candidate vector of interest as a center of the corresponding block in the (N−k+1)th picture as the succeeding picture succeeding the detection object picture. The motion vector detecting unit 51ₖ obtains, as a motion error for the candidate vector of interest, a sum total of differences between the pixel values of pixels at same positions in the corresponding block in the (N−k−1)th picture and in the corresponding block in the (N−k+1)th picture.

The motion vector detecting unit 51ₖ then detects a candidate vector v(x, y) giving a minimum motion error among the 49 vectors v(−3, −3, ) to v(3, 3) shown in FIG. 10 as the motion vector mvₖ of the detection object pixel.

Incidentally, candidate vectors are not limited to the 49 vectors shown in FIG. 10.

In addition, the size of the corresponding blocks is not limited to blocks of 3×3 pixels, or 3 pixel rows and 3 pixel columns.

The process of the evaluation value calculating unit 52ₖ in FIG. 9 will next be further described with reference to FIG. 11.

FIG. 11 shows the Nth to (N−4)th pictures of the interlaced image whose motion vectors are detected by the motion vector detecting units 51₀ to 51₄ in FIG. 9 when the Nth picture is a picture of interest.

The evaluation value calculating unit 52₀ obtains a zeroth evaluation value for evaluating the motion information of a pixel of interest of the picture of interest using the motion vector mv₀ of an interpolation object pixel of the Nth picture as the picture of interest, the motion vector mv₀ being supplied from the motion vector detecting unit 51₀.

Specifically, the evaluation value calculating unit 52₀ obtains, as the zeroth evaluation value, for example an average value ave₀ and a variance dis₀ of the motion vector mv_{0, 0} of a pixel of interest p_{0, 0} of the picture of interest and for example the motion vector mv_{0, -1} of a pixel P_{0, -1} next to the pixel of interest p_{0, 0} on a left, the motion vector mv_{0, -2} of a pixel p_{0, -2} to the left of the pixel of interest p_{0, 0} at a distance of two pixels from the pixel of interest p_{0, 0}, the motion vector mv_{0, 1} of a pixel p_{0, 1} next to the pixel of interest p_{0, 0} on a right, and the motion vector mv_{0, 2} of a pixel p_{0, 2} to the right of the pixel of interest p_{0, 0} at a distance of two pixels from the pixel of interest p_{0, 0} as the motion vectors of a plurality of pixels in the vicinity of the pixel of interest, that is, the motion vectors mv_{0, 0}, mv_{0, -1}, mv_{0, -2}, mv_{0, 1}, and mv_{0, 2} of the five interpolation object pixels in total.

In this case, the average value ave₀ is calculated according to Equation (1).

ave₀=(mv_{0, 0}+mv_{0, -1}+mv_{0, -2}+mv_{0, 1}+mv_{0, 2})/M (1)

The variance dis₀ is calculated in a simple manner, so to speak, according to Equation (2), for example.

dis₀=(|mv_{0, 0}−ave₀|+|mv_{0, -1}−ave₀|+|mv_{0, -2}−ave₀|+|mv_{0, 1}−ave₀|+|mv_{0, 2}−ave₀|)/M (2)

Incidentally, M in Equation (1) and Equation (2) is a normalizing coefficient for normalization, and is the number of motion vectors used in the calculations. Thus, the normalizing coefficient M in Equation (1) and Equation (2) is five.

The evaluation value calculating unit 52₁ obtains a first evaluation value for evaluating the motion information of the pixel of interest of the picture of interest using the motion vector mv₁ of an interpolation object pixel of the (N−1)th picture preceding the picture of interest by one picture, the motion vector mv₁ being supplied from the motion vector detecting unit 51₁.

Specifically, the evaluation value calculating unit 52₁ obtains, as the first evaluation value, for example an average value ave₁ and a variance dis₁ of the motion vectors of a plurality of pixels at positions in the vicinity of the position of the pixel of interest in the (N−1)th picture preceding the picture of interest by one picture.

In this case, the motion vector detecting unit 51ₖ detects motion vectors mvₖ only for interpolation object pixels of the picture. In addition, the picture (detection object picture) whose motion vectors mvₖ are detected by the motion vector detecting unit 51ₖ is an interlaced image. Thus, the positions of pixels (interpolation object pixels) whose motion vectors are detected in the picture of interest coincide with those in a picture distant from the picture of interest by an even number of pictures, whereas the positions of pixels whose motion vectors are detected in the picture of interest are shifted by one line from those in a picture distant from the picture of interest by an odd number of pictures.

Thus, motion vectors are not detected for pixels in a line including the position of the pixel of interest in the (N−1)th picture preceding the picture of interest by one picture. In the (N−1)th picture preceding the picture of interest by one picture, motion vectors are detected for pixels in a line higher than the position of the pixel of interest by one line and a line lower than the position of the pixel of interest by one line.

Accordingly, the evaluation value calculating unit 52₁ obtains, as the first evaluation value, for example an average value ave₁ and a variance dis₁ of for example the motion vector mvd_{1, 0} of a pixel pd_{1, 0} whose position in a horizontal direction coincides with that of the pixel of interest in the line lower than the position of the pixel of interest p_{0, 0} by one line, the motion vector mvd_{1, -1} of a pixel pd_{1, -1} next to the pixel pd_{1, 0} on a left, the motion vector mvd_{1, -2} of a pixel pd_{1, -2} to the left of the pixel pd_{1, 0} at a distance of two pixels from the pixel pd_{1, 0}, the motion vector mvd_{1, 1} of a pixel pd_{1, 1} next to the pixel pd_{1, 0} on a right, the motion vector mvd_{1, 2} of a pixel pd_{1, 2} to the right of the pixel pd_{1, 0} at a distance of two pixels from the pixel pd_{1, 0}, the motion vector mvu_{1, 0} of a pixel pu_{1, 0} whose position in a horizontal direction coincides with that of the pixel of interest in the line higher than the position of the pixel of interest p_{0, 0} by one line, the motion vector mvu_{1, -1} of a pixel pu_{1, -1} next to the pixel pu_{1, 0} on a left, the motion vector mvu_{1, -2} of a pixel pu_{1, -2} to the left of the pixel pu_{1, 0} at a distance of two pixels from the pixel pu_{1, 0} the motion vector mvu_{1, 1} of a pixel pu_{1, 1} next to the pixel pu_{1, 0} on a right, and the motion vector mvu_{1, 2} of a pixel pu_{1, 2} to the right of the pixel pu_{1, 0} at a distance of two pixels from the pixel pu_{1, 0}, that is, the motion vectors mvd_{1, 0,} mvd_{1, -1}, mvd_{1, -2}, mvd_{1, 1}, mvd_{1, 2}, mvu_{1, 0}, mvu_{1, -1}, mvu_{1, -2}, mvu_{1, 1}, and mvu_{1, 2} of the 10 interpolation object pixels in total as the motion vectors of a plurality of pixels at positions in the vicinity of the position of the pixel of interest in the (N−1)th picture preceding the picture of interest by one picture.

In this case, the average value ave₁ is calculated according to Equation (3) similar to Equation (1).

ave₁=(mvd_{1, 0}+mvd_{1, -1}+mvd_{1, -2}+mvd_{1, 1}+mvd_{1, 2}+mvu_{1, 0}+mvu_{1, -1}+mvu_{1, -2}+mvu_{1, 1}+mvu_{1, 2})/M (3)

The variance dis₁ is calculated according to Equation (4) similar to Equation (2).

dis₁=(|mvd_{1, 0}−ave₁|+|mvd_{1, -1}−ave₁|+|mvd_{1, -2}−ave₁|+|mvd_{1, 1}−ave₁|+|mvd_{1, 2}−ave₁|+|mvu_{1, 0}−ave₁|+|mvu_{1, -1}−ave₁|+|mvu_{1, -2}−ave₁|+|mvu_{1, 1}−ave₁|+|mvu_{1, 2}−ave₁|)/M (4)

Incidentally, the normalizing coefficient M in Equation (3) and Equation (4) is 10.

The evaluation value calculating unit 52₂ obtains a second evaluation value for evaluating the motion information of the pixel of interest of the picture of interest using the motion vector mv₂ of an interpolation object pixel of the (N−2)th picture preceding the picture of interest by two pictures, the motion vector mv₂ being supplied from the motion vector detecting unit 51₂.

Specifically, the evaluation value calculating unit 52₂ obtains, as the second evaluation value, an average value ave₂ and a variance dis₂ of the motion vectors of a plurality of pixels at positions in the vicinity of the position of the pixel of interest in the (N−2)th picture preceding the picture of interest by two pictures.

In this case, the positions of pixels (interpolation object pixels) whose motion vectors are detected in the (N−2)th picture preceding the picture of interest by two pictures coincide with those in the picture of interest.

Accordingly, as with the evaluation value calculating unit 52₀, the evaluation value calculating unit 52₂ performs calculations similar to Equation (1) and Equation (2) using the motion vectors of five pixels arranged in a horizontal direction with the position of the pixel of interest as a center of the five pixels in the (N−2)th picture as the motion vectors of a plurality of pixels at positions in the vicinity of the position of the pixel of interest in the (N−2)th picture preceding the picture of interest by two pictures. The evaluation value calculating unit 52₂ thereby obtains an average value ave₂ and a variance dis₂ of the motion vectors of the five pixels as the second evaluation value.

The evaluation value calculating unit 52₃ obtains a third evaluation value for evaluating the motion information of the pixel of interest of the picture of interest using the motion vector mv₃ of an interpolation object pixel of the (N−3)th picture preceding the picture of interest by three pictures, the motion vector mv₃ being supplied from the motion vector detecting unit 51₃.

Specifically, the evaluation value calculating unit 52₃ obtains, as the third evaluation value, an average value ave₃ and a variance dis₃ of the motion vectors of a plurality of pixels at positions in the vicinity of the position of the pixel of interest in the (N−3)th picture preceding the picture of interest by three pictures.

In this case, as in the (N−1)th picture, the positions of pixels (interpolation object pixels) whose motion vectors are detected in the (N−3)th picture preceding the picture of interest by three pictures do not coincide with those in the picture of interest.

Accordingly, as with the evaluation value calculating unit 52₁, the evaluation value calculating unit 52₃ performs calculations similar to Equation (3) and Equation (4) using the motion vectors of 10 pixels in total, that is, the motion vectors of five pixels arranged in the horizontal direction in a line lower than the position of the pixel of interest by one line with the position of the pixel whose position in the horizontal direction coincides with that of the pixel of interest being a center of the five pixels and the motion vectors of five pixels arranged in the horizontal direction in a line higher than the position of the pixel of interest by one line with the position of the pixel whose position in the horizontal direction coincides with that of the pixel of interest being a center of the five pixels in the (N−3)th picture, as the motion vectors of a plurality of pixels at positions in the vicinity of the position of the pixel of interest in the (N−3)th picture preceding the picture of interest by three pictures. The evaluation value calculating unit 52₃ thereby obtains an average value ave₃ and a variance dis₃ of the motion vectors of the 10 pixels as the third evaluation value.

The evaluation value calculating unit 52₄ obtains a fourth evaluation value for evaluating the motion information of the pixel of interest of the picture of interest using the motion vector mv₄ of an interpolation object pixel of the (N−4)th picture preceding the picture of interest by four pictures, the motion vector mv₄ being supplied from the motion vector detecting unit 51₄.

Specifically, the evaluation value calculating unit 52₄ obtains, as the fourth evaluation value, an average value ave₄ and a variance dis₄ of the motion vectors of a plurality of pixels at positions in the vicinity of the position of the pixel of interest in the (N−4)th picture preceding the picture of interest by four pictures.

In this case, the positions of pixels (interpolation object pixels) whose motion vectors are detected in the (N−4)th picture preceding the picture of interest by four pictures coincide with those in the picture of interest.

Accordingly, as with the evaluation value calculating unit 52₀, the evaluation value calculating unit 52₄ performs calculations similar to Equation (1) and Equation (2) using the motion vectors of five pixels arranged in the horizontal direction with the position of the pixel of interest as a center of the five pixels in the (N−4)th picture as the motion vectors of a plurality of pixels at positions in the vicinity of the position of the pixel of interest in the (N−4)th picture preceding the picture of interest by four pictures. The evaluation value calculating unit 52₄ thereby obtains an average value ave₄ and a variance dis₄ of the motion vectors of the five pixels as the fourth evaluation value.

The motion vectors used to obtain the evaluation values (zeroth to fourth evaluation values) for the pixel of interest will hereinafter be referred to as motion vectors for evaluation value calculation as appropriate.

Incidentally, motion vectors close to the position of the pixel of interest spatially and temporally can be employed as motion vectors for evaluation value calculation, and the motion vectors for evaluation value calculation are not limited to the motion vectors described with reference to FIG. 11.

In addition, while in the above-described case, the evaluation value calculating unit 52ₖ obtains both an average value and a variance of motion vectors for evaluation value calculation as an evaluation value, only one of an average value and a variance of motion vectors for evaluation value calculation can be obtained as an evaluation value.

Further, while in the above-described case, the evaluation value calculating unit 52₀ uses the motion vectors of a plurality of pixels including the pixel of interest of the picture of interest as motion vectors for evaluation value calculation, it is also possible, in the picture of interest, to set for example one motion vector of the pixel of interest as a motion vector for evaluation value calculation.

Similarly, also in the pictures preceding the picture of interest by one to four pictures, only the motion vector of one pixel at the position of the pixel of interest or at a position close to the position of the pixel of interest can be set as a motion vector for evaluation value calculation.

When only one motion vector of a picture is set as a motion vector for evaluation value calculation, the motion vector for evaluation value calculation becomes an evaluation value as it is, for example.

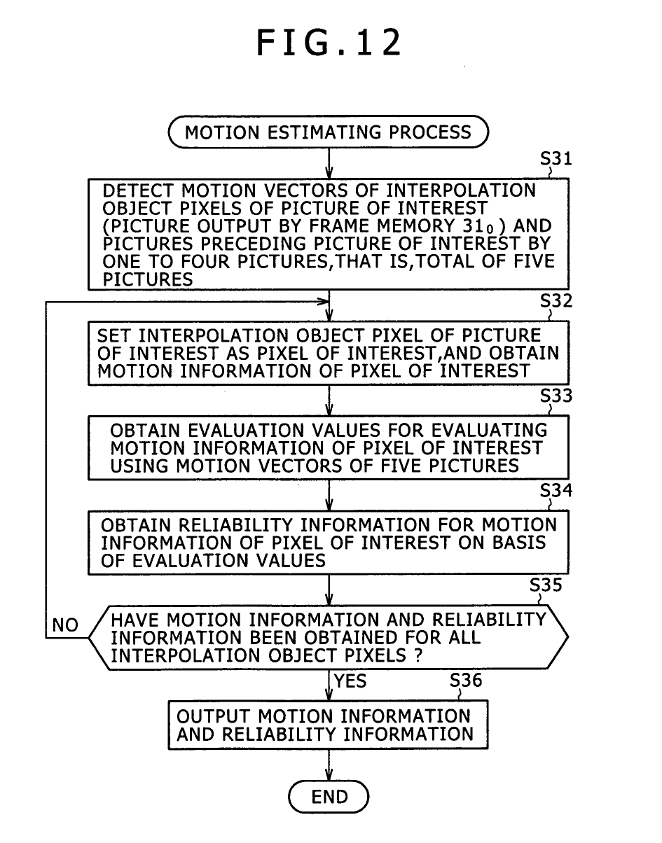

The motion estimating process performed by the motion estimating unit 22 in FIG. 9 will next be described with reference to a flowchart of FIG. 12.

In step S31 of the motion estimating process, the motion vector detecting units 51₀ to 51₄ set a picture stored in the frame memory 31₀ of the memory unit 21 (FIG. 8) as a picture of interest, further set five pictures including the picture of interest and four pictures preceding the picture of interest by one to four pictures as detection object pictures, and detect the motion vectors of interpolation object pixels of the five detection object pictures using seven pictures including the picture of interest supplied from the memory unit 21.

Specifically, for example, when the picture of interest stored in the frame memory 31₀ is the Nth picture, the seven (N+1)th to (N−5)th pictures including the picture of interest are supplied from the memory unit 21 to the motion estimating unit 22.

In the motion estimating unit 22, the motion vector detecting unit 51ₖ detects the motion vector mvₖ of an interpolation object pixel of the (N−k)th picture as described with reference to FIG. 7 using the (N−k−1)th picture as a preceding picture preceding the (N−k)th picture and the (N−k+1)th picture as a succeeding picture succeeding the (N−k)th picture, the (N−k−1)th picture and the (N−k+1)th picture being supplied from the memory unit 21. The motion vector detecting unit 51ₖ then supplies the motion vector mvₖ to the evaluation value calculating unit 52ₖ.

Incidentally, of the motion vector detecting units 51₀ to 51₄, the motion vector detecting unit 51₀ for detecting a motion vector mv₀ of the Nth picture as the picture of interest supplies the motion vector mv₀ of the picture of interest not only to the evaluation value calculating unit 52₀ but also to the motion information calculating unit 53.

After step S31, the process proceeds to step S32, where the motion information calculating unit 53 selects, as a pixel of interest, one of pixels that have not yet been set as a pixel of interest among the interpolation object pixels of the picture of interest, and then obtains the motion information of the pixel of interest using motion vectors mv₀ of the picture of interest (interpolation object pixels of the picture of interest) from the motion vector detecting unit 51₀.

Specifically, the motion information calculating unit 53 obtains for example the average value ave₀ of Equation (1) as the motion information of the pixel of interest using the motion vector of the pixel of interest and the motion vector of a pixel in the vicinity of the pixel of interest among the motion vectors mv₀ of the picture of interest from the motion vector detecting unit 51₀, or specifically, for example, using the five motion vectors mv_{0, 0}, mv_{0, -1}, mv_{0, -2}, mv_{0, 1}, and mv_{0, 2} in Equation (1) which motion vectors have been described with reference to FIG. 11 and serve as motion vectors for evaluation value calculation for the pixel of interest in the picture of interest.

Incidentally, it is possible to adopt, as the motion information of the pixel of interest, not only the average value ave₀ but also for example an average value (ave₀+ave₁)/2 obtained using the average value ave₀ and the average value ave₁ of the 10 motion vectors mvd_{1, 0}, mvd_{1, -1}, mvd_{1, -2}, mvd_{1, 1}, mvd_{1, 2}, mvu_{1, 0}, mvu_{1, -1}, mvu_{1, -2}, mvu_{1, 1}, and mvu_{1, 2} in Equation (3) which motion vectors have been described with reference to FIG. 11 and serve as motion vectors for evaluation value calculation for the pixel of interest in the preceding picture ((N−1)th picture) preceding the picture of interest.

After step S32, the process proceeds to step S33, where the evaluation value calculating units 52₀ to 52₄ obtain a zeroth to a fourth evaluation value using motion vectors of the five detection object pictures.

Specifically, the evaluation value calculating unit 52ₖ obtains, as a kth evaluation value, an average value aveₖ and a variance disₖ of motion vectors for evaluation value calculation described with reference to FIG. 11 among the motion vectors mvₖ of the detection object picture as a picture preceding the picture of interest by k pictures.

The evaluation value calculating unit 52ₖ then supplies the average value aveₖ and the variance disₖ as the kth evaluation value to the reliability determining unit 54. The process proceeds from step S33 to step S34.

In step S34, the reliability determining unit 54 makes reliability determination to determine reliability of the motion information of the pixel of interest which motion information is obtained by the motion information calculating unit 53, using the average values ave₀ to ave₄ and the variances dis₀ to dis₄ as the zeroth to fourth evaluation values supplied from the evaluation value calculating units 52₀ to 52₄, and obtains reliability information indicating the reliability.

In this case, the reliability determining unit 54 makes the reliability determination according to the following control statement (5), for example.

If{(ABS(ave₀−ave₁)<=A) && (ABS(ave₁−ave₂)<=A) && (ABS(ave₂−ave₃)<=A) && (ABS(ave₃−ave₄)<=A) && (ABS(dis₀−dis₁)<=B) && (ABS(dis₁−dis₂)<=B) && (ABS(dis₂−dis₃)<=B) && (ABS(dis₃−dis₄)<=B)}

{Me_valid=1}

Else

{Me_valid=0} (5)

Incidentally, ABS( ) in the control statement (5) denotes the absolute value of a value in the parentheses. A and B are a constant. The constant A is a threshold value for the average values. The constant B is a threshold value for the variances. Further, && denotes a logical product, and Me_valid denotes the reliability information.

The reliability information Me_valid being 1 indicates that the motion information is reliable, that is, that a motion indicated by the motion information is highly likely to represent the motion of the pixel of interest. On the other hand, the reliability information Me_valid being 0 indicates that the motion information is unreliable, that is, that the motion indicated by the motion information is highly likely to represent the wrong motion of the pixel of interest.

The control statement “If{X} {Y}Else{Z} means that Y is performed when X is true and that Z is performed when X is false.

Thus, according to the reliability determination based on the control statement (5), it is determined that the motion information of the pixel of interest is reliable when a determination result of evaluation value determination determining whether a difference between evaluation values obtained for two pictures adjacent to each other is equal to or smaller than a predetermined threshold value (or is smaller than the predetermined threshold value) is true, such determination being made for all sets of two pictures adjacent to each other of the five consecutive pictures including the picture of interest.

Specifically, according to the reliability determination based on the control statement (5), an evaluation value determination is made to determine whether a difference (the absolute value of the difference) ABS(ave₀−ave₁) between the average value ave₀ as the zeroth evaluation value obtained for the picture of interest and the average value ave₁ as the first evaluation value obtained for the picture preceding the picture of interest by one picture is equal to or smaller than the threshold value A (this evaluation value determination will hereinafter be referred to as a first evaluation value determination for the average values as appropriate).

Similarly, according to the reliability determination based on the control statement (5), an evaluation value determination is made to determine whether a difference ABS(ave₁−ave₂) between the average value ave₁ as the first evaluation value obtained for the picture preceding the picture of interest by one picture and the average value ave₂ as the second evaluation value obtained for the picture preceding the picture of interest by two pictures is equal to or smaller than the threshold value A (this evaluation value determination will hereinafter be referred to as a second evaluation value determination for the average values as appropriate), an evaluation value determination is made to determine whether a difference ABS(ave₂−ave₃) between the average value ave₂ as the second evaluation value obtained for the picture preceding the picture of interest by two pictures and the average value ave₃ as the third evaluation value obtained for the picture preceding the picture of interest by three pictures is equal to or smaller than the threshold value A (this evaluation value determination will hereinafter be referred to as a third evaluation value determination for the average values as appropriate), and an evaluation value determination is made to determine whether a difference ABS(ave₃−ave₄) between the average value ave₃ as the third evaluation value obtained for the picture preceding the picture of interest by three pictures and the average value ave₄ as the fourth evaluation value obtained for the picture preceding the picture of interest by four pictures is equal to or smaller than the threshold value A (this evaluation value determination will hereinafter be referred to as a fourth evaluation value determination for the average values as appropriate).

In addition, according to the reliability determination based on the control statement (5), an evaluation value determination is made to determine whether a difference ABS(dis₀−dis₁) between the variance dis₀ as the zeroth evaluation value obtained for the picture of interest and the variance dis₁ as the first evaluation value obtained for the picture preceding the picture of interest by one picture is equal to or smaller than the threshold value B (this evaluation value determination will hereinafter be referred to as a first evaluation value determination for the variances as appropriate).

Similarly, according to the reliability determination based on the control statement (5), an evaluation value determination is made to determine whether a difference ABS(dis₁-dis₂) between the variance dis₁ as the first evaluation value obtained for the picture preceding the picture of interest by one picture and the variance dis₂ as the second evaluation value obtained for the picture preceding the picture of interest by two pictures is equal to or smaller than the threshold value B (this evaluation value determination will hereinafter be referred to as a second evaluation value determination for the variances as appropriate), an evaluation value determination is made to determine whether a difference ABS(dis₂−dis₃) between the variance dis₂ as the second evaluation value obtained for the picture preceding the picture of interest by two pictures and the variance dis₃ as the third evaluation value obtained for the picture preceding the picture of interest by three pictures is equal to or smaller than the threshold value B (this evaluation value determination will hereinafter be referred to as a third evaluation value determination for the variances as appropriate), and an evaluation value determination is made to determine whether a difference ABS(dis₃−dis₄) between the variance dis₃ as the third evaluation value obtained for the picture preceding the picture of interest by three pictures and the variance dis₄ as the fourth evaluation value obtained for the picture preceding the picture of interest by four pictures is equal to or smaller than the threshold value B (this evaluation value determination will hereinafter be referred to as a fourth evaluation value determination for the variances as appropriate).

Then, according to the reliability determination, it is determined that the motion information of the pixel of interest is reliable when determination results of the first to fourth evaluation value determinations for the average values and the first to fourth evaluation value determinations for the variances are all true.

Incidentally, the reliability determination can be made using either the average values ave₀ to ave₄ or the variances dis₀ to dis₄ as evaluation values instead of both of the average values ave₀ to ave₄ and the variances dis₀ to dis₄ as evaluation values.

When the reliability determination is made using only the average values ave₀ to ave₄, it is determined that the motion information of the pixel of interest is reliable when the determination results of the first to fourth evaluation value determinations for the average values are all true. In this case, it suffices for the evaluation value calculating units 52₀ to 52₄ to obtain only the average values ave₀ to ave₄ as evaluation values.

When the reliability determination is made using only the variances dis₀ to dis₄, it is determined that the motion information of the pixel of interest is reliable when the determination results of the first to fourth evaluation value determinations for the variances are all true. In this case, it suffices for the evaluation value calculating units 52₀ to 52₄ to obtain only the variances dis₀ to dis₄ as evaluation values.

After the reliability determining unit 54 makes the reliability determination to determine the reliability of the motion information of the pixel of interest and obtains the reliability information in step S34, the process proceeds to step S35, where the motion information calculating unit 53 (or the reliability determining unit 54) determines whether motion information and reliability information are obtained for all the interpolation object pixels of the picture of interest.

When it is determined in step S35 that motion information and reliability information have not yet been obtained for all the interpolation object pixels of the picture of interest, that is, that the interpolation object pixels of the picture of interest include pixels for which motion information and reliability information have not yet been obtained, the process returns to step S32, where one of the pixels for which motion information and reliability information have not yet been obtained among the interpolation object pixels of the picture of interest is set as a new pixel of interest, and the same process from step S32 on down is performed for the new pixel of interest.

When it is determined in step S35 that motion information and reliability information have been obtained for all the interpolation object pixels of the picture of interest, the process proceeds to step S36, where the motion information calculating unit 53 sequentially outputs the motion information of the interpolation object pixels of the picture of interest to the progressive image generating unit 23, and the reliability determining unit 54 sequentially outputs the reliability information for the motion information output by the motion information calculating unit 53 to the progressive image generating unit 23. Thereby the motion estimating process is ended.

FIG. 13 is a block diagram showing an example of configuration of the progressive image generating unit 23 in FIG. 2.

The progressive image generating unit 23 in FIG. 13 includes an inter-field interpolating unit 61, an intra-field interpolating unit 62, a selecting unit 63, and a combining unit 64.

The inter-field interpolating unit 61 is supplied from the memory unit 21 (FIG. 2) with the preceding picture preceding the picture of interest and the succeeding picture succeeding the picture of interest. Thus, when the picture of interest is the Nth picture, the inter-field interpolating unit 61 is supplied from the memory unit 21 with the (N−1)th picture as the preceding picture preceding the picture of interest and the (N+1)th picture as the succeeding picture succeeding the picture of interest.

Further, the inter-field interpolating unit 61 is supplied from the motion estimating unit 22 (FIG. 2) with the motion information of the pixel of interest.

The inter-field interpolating unit 61 performs interpolation referred to as inter-field interpolation or motion compensation interpolation using the pixel values of pixels in the preceding picture and the succeeding picture from the memory unit 21 and the motion information of the pixel of interest from the motion estimating unit 22. The inter-field interpolating unit 61 thereby obtains an inter-field interpolation value (second interpolation value) as one candidate for an interpolation value for the pixel of interest (the pixel value of the pixel of interest) as an interpolation object pixel. The inter-field interpolating unit 61 then supplies the inter-field interpolation value to the selecting unit 63.

Specifically, the inter-field interpolating unit 61 for example obtains, as the inter-field interpolation value, the average value of the pixel value of a pixel situated at the starting point of a vector as the motion information of the pixel of interest among the pixels of the preceding picture and the pixel value of a pixel situated at the ending point of the vector as the motion information of the pixel of interest among the pixels of the succeeding picture. The inter-field interpolating unit 61 then supplies the inter-field interpolation value to the selecting unit 63.

The intra-field interpolating unit 62 is supplied with the picture of interest from the memory unit 21 (FIG. 2).

The intra-field interpolating unit 62 performs intra-field interpolation using the pixel value of a pixel of the picture of interest from the memory unit 21. The intra-field interpolating unit 62 thereby obtains an intra-field interpolation value (first interpolation value) as another candidate for an interpolation value for the pixel of interest as an interpolation object pixel. The intra-field interpolating unit 62 then supplies the intra-field interpolation value to the selecting unit 63.

Specifically, the intra-field interpolating unit 62 for example obtains, as the intra-field interpolation value, the average value of the pixel value of a pixel adjacent to the pixel of interest at a position above the pixel of interest and the pixel value of a pixel adjacent to the pixel of interest at a position below the pixel of interest among the pixels of the picture of interest. The intra-field interpolating unit 62 then supplies the intra-field interpolation value to the selecting unit 63.

The selecting unit 63 is supplied with the inter-field interpolation value from the inter-field interpolating unit 61 and the intra-field interpolation value from the intra-field interpolating unit 62, as described above. In addition, the selecting unit 63 is supplied with the reliability information Me_valid for the motion information of the pixel of interest from the motion estimating unit 22 (FIG. 2).

The selecting unit 63 selects one of the inter-field interpolation value from the inter-field interpolating unit 61 and the intra-field interpolation value from the intra-field interpolating unit 62 as an interpolation value for the pixel of interest according to the reliability information Me_valid from the motion estimating unit 22.

Specifically, when the reliability information Me_valid from the motion estimating unit 22 indicates that the motion information of the pixel of interest is unreliable, that is, when the reliability information Me_valid is zero, the selecting unit 63 selects the intra-field interpolation value from the intra-field interpolating unit 62 from the inter-field interpolation value from the inter-field interpolating unit 61 and the intra-field interpolation value from the intra-field interpolating unit 62. The selecting unit 63 outputs the intra-field interpolation value as an interpolation value for the pixel of interest (the pixel value of the pixel of interest) to the combining unit 64.

When the reliability information Me_valid from the motion estimating unit 22 indicates that the motion information of the pixel of interest is reliable, that is, when the reliability information Me_valid is one, the selecting unit 63 selects the inter-field interpolation value from the inter-field interpolating unit 61 from the inter-field interpolation value from the inter-field interpolating unit 61 and the intra-field interpolation value from the intra-field interpolating unit 62. The selecting unit 63 outputs the inter-field interpolation value as an interpolation value for the pixel of interest (the pixel value of the pixel of interest) to the combining unit 64.

The combining unit 64 is supplied with the interpolation value for the pixel of interest of the picture of interest, that is, the interpolation value for the interpolation object pixel of the picture of interest from the selecting unit 63 as well as the picture of interest from the memory unit 21 (FIG. 2).

The combining unit 64 combines the pixel values of the picture of interest from the memory unit 21 with the interpolation value of the pixel of interest from the selecting unit 63, that is, sets the interpolation value of the pixel of interest from the selecting unit 63 as the pixel value of the pixel of interest in the picture of interest from the memory unit 21. The combining unit 64 thereby generates a picture of a progressive image which picture is composed of the pixels having a pixel value in the picture of interest and the interpolation object pixels whose pixel values (interpolation values) are determined. The combining unit 64 then supplies the picture of the progressive image to the display panel 16 (FIG. 1).

Incidentally, in addition to selecting one of the inter-field interpolation value from the inter-field interpolating unit 61 and the intra-field interpolation value from the intra-field interpolating unit 62 as interpolation value for the pixel of interest according to the reliability information Me_valid, the selecting unit 63 can perform weighting addition of the inter-field interpolation value and the intra-field interpolation value with weights according to the reliability information Me_valid, and output a result of the weighting addition as interpolation value for the pixel of interest.

Specifically, in the above-described case, according to the reliability determination based on the control statement (5), the reliability determining unit 54 (FIG. 9) outputs the reliability information whose value is 1 when the determination results of the first to fourth evaluation value determinations for the average values and the first to fourth evaluation value determinations for the variances, that is, the eight evaluation value determinations in total are all true, and outputs the reliability information whose value is 0 when even one of the determination results of the eight evaluation value determinations is false. In addition to this, the reliability determining unit 54 can output the reliability information whose value approaches 1 as the number of true determination results of the eight evaluation value determinations is increased (the reliability information whose value approaches 0 as the number of false determination results of the eight evaluation value determinations is increased).

In this case, the selecting unit 63 can perform weighting addition of the inter-field interpolation value P and the intra-field interpolation value Q according to an equation Me_valid×P+(1−Me_valid)×Q, for example, and output a result of the weighting addition as interpolation value for the pixel of interest.

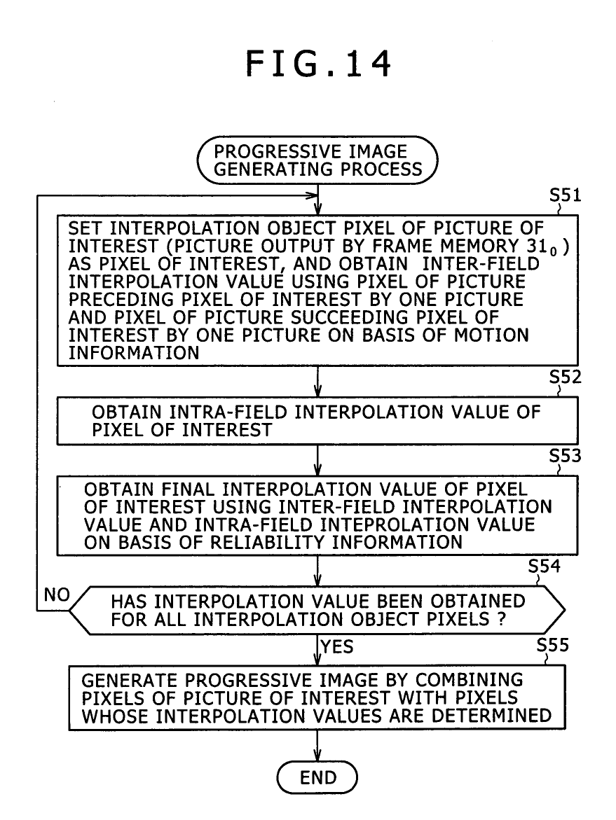

The progressive image generating process performed in the progressive image generating unit 23 in FIG. 13 will next be described with reference to a flowchart of FIG. 14.

In the progressive image generating unit 23, the inter-field interpolating unit 61 is supplied from the memory unit 21 (FIG. 2) with the preceding picture preceding the picture of interest and the succeeding picture succeeding the picture of interest. In addition, the picture of interest is supplied from the memory unit 21 to the intra-field interpolating unit 62 and the combining unit 64.

In step S51, the inter-field interpolating unit 61 selects one of pixels that have not yet been set as a pixel of interest among the interpolation object pixels of the picture of interest as a pixel of interest. Further, the inter-field interpolating unit 61 in step S51 waits for the motion information of the pixel of interest to be supplied to the inter-field interpolating unit 61 from the motion estimating unit 22 (FIG. 2) and waits for reliability information for the motion information of the pixel of interest to be supplied to the selecting unit 63 from the motion estimating unit 22. The inter-field interpolating unit 61 then obtains an inter-field interpolation value for the pixel of interest by performing inter-field interpolation using the pixel values of pixels in the preceding picture and the succeeding picture from the memory unit 21 and the motion information of the pixel of interest from the motion estimating unit 22.

Then, the inter-field interpolating unit 61 supplies the inter-field interpolation value for the pixel of interest to the selecting unit 63. The process proceeds from step S51 to step S52.

The intra-field interpolating unit 62 in step S52 obtains an intra-field interpolation value for the pixel of interest by performing intra-field interpolation using the pixel values of pixels of the picture of interest from the memory unit 21. The intra-field interpolating unit 62 then supplies the intra-field interpolation value for the pixel of interest to the selecting unit 63. The process proceeds from step S52 to step S53.

The selecting unit 63 in step S53 obtains an interpolation value for the pixel of interest on the basis of the reliability information Me_valid from the motion estimating unit 22 using the inter-field interpolation value from the inter-field interpolating unit 61 and the intra-field interpolation value from the intra-field interpolating unit 62. The selecting unit 63 then supplies the interpolation value for the pixel of interest to the combining unit 64. The process proceeds to step S54.

Specifically, the selecting unit 63 for example selects one of the inter-field interpolation value and the intra-field interpolation value according to the reliability information Me_valid. The selecting unit 63 supplies the selected interpolation value as interpolation value for the pixel of interest to the combining unit 64.

The inter-field interpolating unit 61 in step S54 determines whether interpolation values are obtained for all the interpolation object pixels of the picture of interest.

When it is determined in step S54 that interpolation values are not yet obtained for all the interpolation object pixels of the picture of interest, the process returns to step S51, where one of the pixels that have not yet been set as a pixel of interest among the interpolation object pixels of the picture of interest is set as a new pixel of interest, and the same process from step S51 on down is performed.

When it is determined in step S54 that interpolation values are obtained for all the interpolation object pixels of the picture of interest, the process proceeds to step S55, where the combining unit 64 generates a picture of a progressive image by combining pixels having a pixel value in the picture of interest from the memory unit 21 with pixels whose pixel values are the interpolation values from the selecting unit 63. The combining unit 64 then supplies the picture of the progressive image to the display panel 16 (FIG. 1). Thereby the progressive image generating process is ended.

As described above, the motion estimating unit 22 obtains motion information of a pixel of interest using a motion vector of the pixel of interest and a motion vector of a pixel in the vicinity of the pixel of interest and outputs the motion information of the pixel of interest, and obtains an evaluation value for evaluating the motion information of the pixel of interest using motion vectors of a plurality of pixels of a picture of interest, obtains an evaluation value for evaluating the motion information of the pixel of interest using motion vectors of a plurality of pixels of another picture adjacent to the picture of interest, determines reliability of the motion information of the pixel of interest using the evaluation values, and outputs reliability information indicating the reliability. Therefore the reliability information indicating the reliability of the motion information can be obtained with higher accuracy and at lower cost.

Specifically, when the picture of interest is the Nth picture, the motion vector detecting units 51₀ to 51₄ in the motion estimating unit 22 in FIG. 9 detect the motion vectors mv₀ to mv₄ of pixels of the Nth picture as the picture of interest and the (N−1)th to (N−4)th pictures adjacent to the picture of interest, that is, the five Nth to (N−4)th pictures in total.

Further, the motion information calculating unit 53 obtains the motion information of the pixel of interest using the motion vector of the pixel of interest and the motion vector of a pixel in the vicinity of the pixel of interest, the motion vectors being detected by the motion vector detecting unit 51₀ for the picture of interest, that is, using the motion vectors mv_{0, 0}, mv_{0, -1}, mv_{0, -2}, mv_{0, 1}, and mv_{0, 2} in Equation (1).

The evaluation value calculating units 52₀ to 52₄ obtain average values ave₀ to ave₄ and variances dis₀ to dis₄ as evaluation values for evaluating the motion information of the pixel of interest using the motion vectors mv₀ to mv₄ of the Nth to (N−4)th pictures.

Then, the reliability determining unit 54 determines reliability of the motion information of the pixel of interest using the average values ave₀ to ave₄ and the variances dis₀ to dis₄ as evaluation values obtained for the Nth to (N−4)th pictures, and obtains reliability information indicating the reliability.

Thus, because the reliability information is obtained using the (N−1)th to (N−4)th pictures adjacent to the picture of interest as well as the Nth picture as the picture of interest, the reliability information that accurately indicates the reliability of the motion information can be obtained even when macroblocks (corresponding blocks) of small size are used at the time of detecting the motion vectors. That is, accurate reliability information can be obtained at low cost.

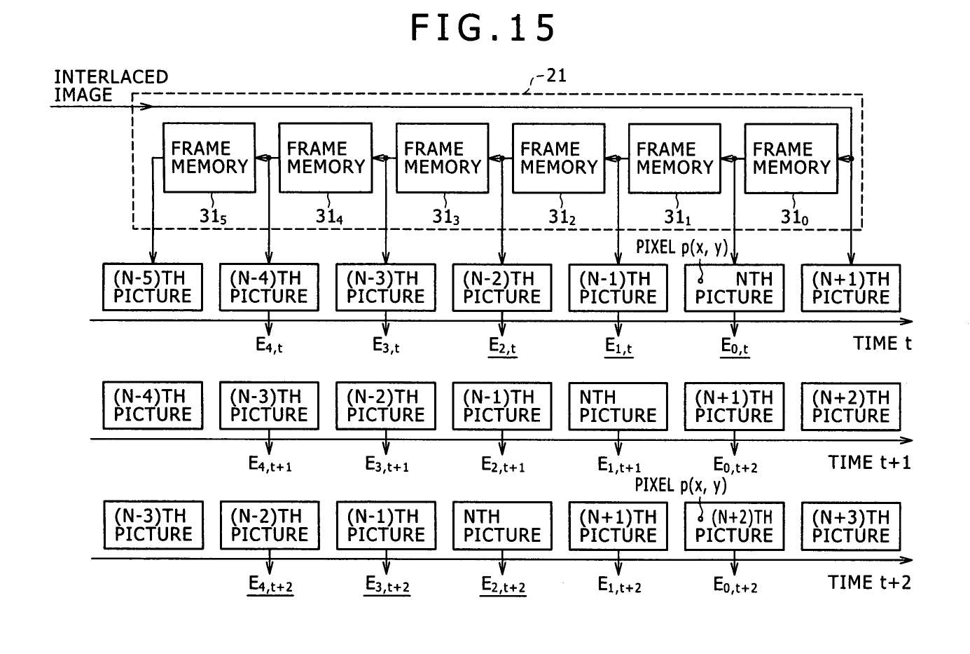

FIG. 15 shows pictures supplied by the memory unit 21 (FIG. 8) to the motion estimating unit 22 (FIG. 9) at times t, t+1, and t+2.

Suppose that the memory unit 21 supplies the motion estimating unit 22 with the (N+1)th to (N−5)th pictures with the Nth picture as the picture of interest at time t.

In this case, the five motion vector detecting units 51₀ to 51₄ in the motion estimating unit 22 (FIG. 9) detect the motion vectors mv₀ to mv₄ of the Nth to (N−4)th pictures using the (N+1)th to (N−5)th pictures from the memory unit 21, and then supplies the motion vectors mv₀ to mv₄ to the evaluation value calculating units 52₀ to 52₄.

Supposing that a pixel p(x, y) that is an xth pixel from an upper left in a right direction and is a yth pixel from the upper left in a downward direction among the interpolation object pixels of the Nth picture as the picture of interest is the pixel of interest, the evaluation value calculating unit 52ₖ obtains an average value aveₖ and a variance disₖ as a kth evaluation value using motion vectors for evaluation value calculation for the pixel of interest p(x, y) among the motion vectors mvₖ from the motion vector detecting unit 51ₖ.

When the kth evaluation value obtained using the motion vectors for evaluation value calculation among the motion vectors detected from the picture preceding the picture of interest by k pictures is represented as E_{k, t}, the evaluation value calculating unit 52₀ at time t obtains a zeroth evaluation value E_{0, t} using the motion vectors for evaluation value calculation of the Nth picture as the picture of interest.

Similarly, at time t, the evaluation value calculating unit 52₁ obtains a first evaluation value E_{1, t} using the motion vectors for evaluation value calculation of the (N−1)th picture preceding the picture of interest by one picture, and the evaluation value calculating unit 52₂ obtains a second evaluation value E_{2, t} using the motion vectors for evaluation value calculation of the (N−2)th picture preceding the picture of interest by two pictures. Further, at time t, the evaluation value calculating unit 52₃ obtains a third evaluation value E_{3, t} using the motion vectors for evaluation value calculation of the (N−3)th picture preceding the picture of interest by three pictures, and the evaluation value calculating unit 52₄ obtains a fourth evaluation value E_{4, t} using the motion vectors for evaluation value calculation of the (N−4)th picture preceding the picture of interest by four pictures.

The (N+1)th frame thereafter becomes a picture of interest at time t+1 at which the time of one picture has passed from time t. The evaluation value calculating unit 52₀ obtains a zeroth evaluation value E_{0, t+1} using the motion vectors for evaluation value calculation of the (N+1)th picture as the picture of interest.

Similarly, at time t+1, the evaluation value calculating unit 52₁ obtains a first evaluation value E_{1, t+1} using the motion vectors for evaluation value calculation of the Nth picture preceding the picture of interest by one picture, and the evaluation value calculating unit 52₂ obtains a second evaluation value E_{2, t+1} using the motion vectors for evaluation value calculation of the (N−1)th picture preceding the picture of interest by two pictures. Further, at time t+1, the evaluation value calculating unit 52₃ obtains a third evaluation value E_{3, t+1} using the motion vectors for evaluation value calculation of the (N−2)th picture preceding the picture of interest by three pictures, and the evaluation value calculating unit 52₄ obtains a fourth evaluation value E_{4, t+1} using the motion vectors for evaluation value calculation of the (N−3)th picture preceding the picture of interest by four pictures.

In this case, the positions of the interpolation object pixels of the Nth picture do not coincide with the positions of the interpolation object pixels of the (N+1)th picture. Therefore, when the evaluation values are obtained with the pixel p(x, y) of the Nth picture set as the pixel of interest, the evaluation values are not obtained with the pixel p(x, y) of the (N+1)th picture set as the pixel of interest.

An (N+2)th frame thereafter becomes a picture of interest at time t+2 at which the time of one picture has passed from time t+1. The evaluation value calculating unit 52₀ obtains a zeroth evaluation value E_{0, t+2} using the motion vectors for evaluation value calculation of the (N+2)th picture as the picture of interest.

Similarly, at time t+2, the evaluation value calculating unit 52₁ obtains a first evaluation value E_{1, t+2} using the motion vectors for evaluation value calculation of the (N+1)th picture preceding the picture of interest by one picture, and the evaluation value calculating unit 52₂ obtains a second evaluation value E_{2, t+2} using the motion vectors for evaluation value calculation of the Nth picture preceding the picture of interest by two pictures. Further, at time t+2, the evaluation value calculating unit 52₃ obtains a third evaluation value E_{3, t+2} using the motion vectors for evaluation value calculation of the (N−1)th picture preceding the picture of interest by three pictures, and the evaluation value calculating unit 52₄ obtains a fourth evaluation value E_{4, t+2} using the motion vectors for evaluation value calculation of the (N−2)th picture preceding the picture of interest by four pictures.

In this case, the positions of the interpolation object pixels of the Nth picture coincide with the positions of the interpolation object pixels of the (N+2)th picture. Therefore, when the evaluation values are obtained with the pixel p(x, y) of the Nth picture set as the pixel of interest, the evaluation values are obtained with the pixel p(x, y) of the (N+2)th picture also set as the pixel of interest.

The evaluation value E_{0, t} obtained from the Nth picture with the pixel p(x, y) of the Nth picture as the picture of interest set as the pixel of interest at time t coincides with the evaluation value E_{2, t+2} obtained from the Nth picture preceding the picture of interest by two pictures with the pixel p(x, y) of the (N+2)th picture as the picture of interest set as the pixel of interest at time t+2.

Similarly, the evaluation value E_{1, t} obtained from the (N−1)th picture preceding the picture of interest by one picture with the pixel p(x, y) of the Nth picture as the picture of interest set as the pixel of interest at time t coincides with the evaluation value E_{3, t+2} obtained from the (N−1)th picture preceding the picture of interest by three pictures with the pixel p(x, y) of the (N+2)th picture as the picture of interest set as the pixel of interest at time t+2. Further, the evaluation value E_{2, t} obtained from the (N−2)th picture preceding the picture of interest by two pictures with the pixel p(x, y) of the Nth picture as the picture of interest set as the pixel of interest at time t coincides with the evaluation value E_{4, t+2} obtained from the (N−2)th picture preceding the picture of interest by four pictures with the pixel p(x, y) of the (N+2)th picture as the picture of interest set as the pixel of interest at time t+2.

As the reliability determination based on the control statement (5), the first to fourth evaluation value determinations for the average values and the first to fourth evaluation value determinations for the variances, that is, the eight evaluation value determinations in total are made. When the determination results of the eight evaluation value determinations are all true, the reliability information is one, which is a value indicating that the motion information is of high reliability. When even one of the determination results of the eight evaluation value determinations is false, the reliability information is zero, which is a value indicating that the motion information is of low reliability.

The first evaluation value determination for the average values and the variances (this determination will hereinafter be referred to simply as the first evaluation value determination as appropriate) which determination is made with the pixel p(x, y) as the pixel of interest at time t is made using the evaluation values E_{0, t} and E_{1, t}.

The second evaluation value determination for the average values and the variances (this determination will hereinafter be referred to simply as the second evaluation value determination as appropriate) which determination is made with the pixel p(x, y) as the pixel of interest at time t is made using the evaluation values E_{1, t} and E_{2, t}.

The third evaluation value determination for the average values and the variances (this determination will hereinafter be referred to simply as the third evaluation value determination as appropriate) which determination is made with the pixel p(x, y) as the pixel of interest at time t is made using the evaluation values E_{2, t} and E_{3, t}.

The fourth evaluation value determination for the average values and the variances (this determination will hereinafter be referred to simply as the fourth evaluation value determination as appropriate) which determination is made with the pixel p(x, y) as the pixel of interest at time t is made using the evaluation values E_{3, t} and E_{4, t}.

The first evaluation value determination which determination is made with the pixel p(x, y) as the pixel of interest at time t+2 is made using the evaluation values E_{0, t+2} and E_{1 , t+2}.

The second evaluation value determination which determination is made with the pixel p(x, y) as the pixel of interest at time t+2 is made using the evaluation values E_{1, t+2} and E_{2, t+2}.

The third evaluation value determination which determination is made with the pixel p(x, y) as the pixel of interest at time t+2 is made using the evaluation values E_{2, t+2} and E_{3, t+2}.

The fourth evaluation value determination which determination is made with the pixel p(x, y) as the pixel of interest at time t+2 is made using the evaluation values E_{3, t+2} and E_{4, t+2}.

As described above, the evaluation value E_{0, t} at time t coincides with the evaluation value E_{2, t+2} at time t+2. The evaluation value E_{1, t} at time t coincides with the evaluation value E_{3, t+2} at time t+2. The evaluation value E_{2, t} at time t coincides with the evaluation value E_{4, t+2} at time t+2.

Thus, the determination result of the first evaluation value determination made using the evaluation values E_{0, t} and E_{1, t} at time t coincides with the determination result of the third evaluation value determination made using the evaluation values E_{2, t+2} and E_{3, t+2} at time t+2.

In addition, the determination result of the second evaluation value determination made using the evaluation values E_{1, t} and E_{2, t} at time t coincides with the determination result of the fourth evaluation value determination made using the evaluation values E_{3, t+2} and E_{4, t+2} at time t+2.

Hence, the reliability determination at time t+2 can be made using the zeroth to second evaluation values E_{0, t+2}, E_{1, t+2}, and E_{2, t+2}, which are used in the first and second evaluation value determinations, and a determination in-progress result as an in-progress result of a past reliability determination, that is, the determination results of the first and second evaluation value determinations at time t preceding time t+2 by the time of two pictures.

The reliability determination using the determination in-progress results of the past reliability determination can be made according to a control statement (6) in place of the control statement (5).

If{(ABS(ave₀−ave₁)<=A) && (ABS(ave₁−ave₂)<=A) && (ABS(dis₀−dis₁)<=B) && (ABS(dis₁−dis₂)<=B) && (valid_{—}d==1)}

{Me_valid=1}

Else

{Me_valid=0} (6)

Incidentally, valid_d in Equation (6) denotes the determination in-progress result of the reliability determination at the time preceding by the time of two pictures. When the determination results of the first evaluation value determination (ABS(ave₀−ave₁)<=A) for the average values, the second evaluation value determination (ABS(ave₁−ave₂)<=A) for the average values, the first evaluation value determination (ABS(dis₀−dis₁)<=B) for the variances, and the second evaluation value determination (ABS(dis₁−dis₂)) for the variances in the reliability determination at the time preceding by the time of two pictures are all true, the determination in-progress result valid_d is one (true), which is a value indicating that the determination results are all true.

When even one of the determination results of the first evaluation value determination (ABS(ave₀−ave₁)<=A) for the average values, the second evaluation value determination (ABS(ave₁−ave₂)<=A) for the average values, the first evaluation value determination (ABS(dis₀−dis₁)<=B) for the variances, and the second evaluation value determination (ABS(dis₁−dis₂)) for the variances in the reliability determination at the time preceding by the time of two pictures is false, the determination in-progress result valid_d is zero (false), which is a value indicating that at least one of the determination results is false.

By using the determination in-progress result valid_d of the past reliability determination, the reliability determination according to the control statement (6) can be made without using the average value ave₃ and the variance dis₃ as the third evaluation value or the average value ave₄ and the variance dis₄ as the fourth evaluation value.

It is therefore unnecessary to obtain the third and fourth evaluation values or, in turn, the motion vectors of the picture preceding the picture of interest by three pictures and the picture preceding the picture of interest by four pictures.

FIG. 16 is a block diagram showing an example of configuration of the motion estimating unit 22 (a second example of configuration of the motion estimating unit 22) in FIG. 2 which unit makes reliability determination using a determination in-progress result of past reliability determination as described above.

Incidentally, in FIG. 16, parts corresponding to those of FIG. 9 are identified by the same reference numerals, and description thereof will be omitted in the following as appropriate.

The motion estimating unit 22 in FIG. 16 has a motion information calculating unit 53 in common with the motion estimating unit 22 in FIG. 9.

On the other hand, the motion estimating unit 22 in FIG. 16 differs from the motion estimating unit 22 in FIG. 9 in that the motion estimating unit 22 in FIG. 16 has three motion vector detecting units 51₀ to 51₂ in place of the five motion vector detecting units 51₀ to 51₄, three evaluation value calculating units 52₀ to 52₂ in place of the five evaluation value calculating units 52₀ to 52₄, and a reliability determining unit 57 in place of the reliability determining unit 54.

Further, the motion estimating unit 22 in FIG. 16 differs from the motion estimating unit 22 in FIG. 9 in that the motion estimating unit 22 in FIG. 16 is newly provided with a determination in-progress result storing unit 56.

The determination in-progress result storing unit 56 stores a determination in-progress result as an in-progress result of reliability determination, which result is supplied from the reliability determining unit 57.

The reliability determining unit 57 determines reliability of motion information of a pixel of interest using evaluation values obtained by the three evaluation value calculating units 52₀ to 52₂ and the determination in-progress result of the past reliability determination which result is stored in the determination in-progress result storing unit 56. The reliability determining unit 57 then supplies reliability information for the motion information of the pixel of interest, the reliability information being obtained by the reliability determination, to the progressive image generating unit 23 (FIG. 2).

Specifically, the motion estimating unit 22 in FIG. 16 has merely the three motion vector detecting units 51₀ to 51₂ in place of the five motion vector detecting units 51₀ to 51₄ in FIG. 9. In addition, the motion estimating unit 22 in FIG. 16 has merely the three evaluation value calculating units 52₀ to 52₂ in place of the five evaluation value calculating units 52₀ to 52₄ in FIG. 9.

Thus, when the picture of interest is the Nth picture, the motion vector detecting units 51₀ to 51₂ in the motion estimating unit 22 in FIG. 16 obtain the motion vectors of the Nth to (N−2)th pictures using the (N+1)th to (N−3)th pictures.

Then, the three evaluation value calculating units 52₀ to 52₂ obtain the zeroth to second evaluation values using the motion vectors of the Nth to (N−2)th pictures, respectively. The evaluation value calculating units 52₀ to 52₂ supply the zeroth to second evaluation values to the reliability determining unit 57.

The reliability determining unit 57 determines reliability of the motion information of the pixel of interest according to the control statement (6) using the zeroth to second evaluation values supplied from the three evaluation value calculating units 52₀ to 52₂ as described above and determination results of first and second evaluation value determinations as the determination in-progress result of the reliability determination made at the time preceding by the time of two pictures, the determination in-progress result being stored in the determination in-progress result storing unit 56.

In addition, the reliability determining unit 57 supplies a determination in-progress result of the reliability determination, that is, determination results of first and second evaluation value determinations made using the zeroth to second evaluation values to the determination in-progress result storing unit 56 to store the determination in-progress result of the reliability determination in the determination in-progress result storing unit 56. The determination in-progress result stored in the determination in-progress result storing unit 56 is used in reliability determination at a time succeeding by the time of two pictures.

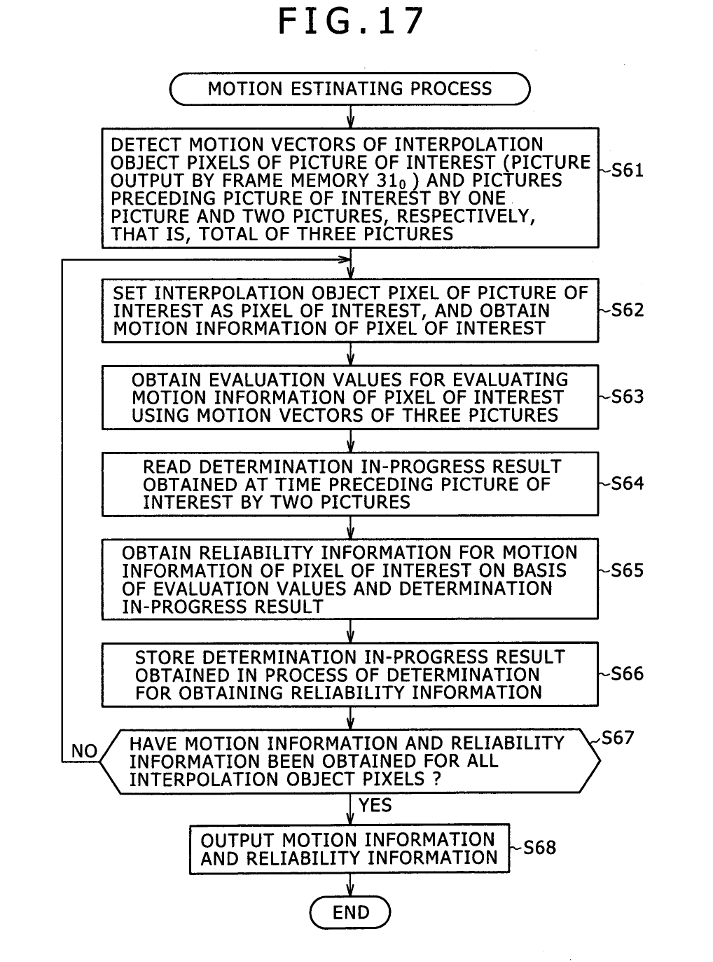

The motion estimating process performed by the motion estimating unit 22 in FIG. 16 will next be described with reference to a flowchart of FIG. 17.

In step S61 of the motion estimating process, the motion vector detecting units 51₀ to 51₂ set a picture stored in the frame memory 31₀ of the memory unit 21 (FIG. 8) as a picture of interest, further set three pictures including the picture of interest and two pictures preceding the picture of interest by one picture and two pictures as detection object pictures, and detect the motion vectors of interpolation object pixels of the three detection object pictures using five pictures including the picture of interest supplied from the memory unit 21.

Specifically, for example, when the picture of interest stored in the frame memory 31₀ is the Nth picture, the five (N+1)th to (N−3)th pictures including the picture of interest are supplied from the memory unit 21 to the motion estimating unit 22.

In the motion estimating unit 22, the motion vector detecting unit 51ₖ detects the motion vector mvₖ (k=0, 1, 2) of an interpolation object pixel of the (N−k)th picture as described with reference to FIG. 7 using the (N−k−1)th picture as a preceding picture preceding the (N−k)th picture and the (N−k+1)th picture as a succeeding picture succeeding the (N−k)th picture, the (N−k−1)th picture and the (N−k+1)th picture being supplied from the memory unit 21. The motion vector detecting unit 51ₖ then supplies the motion vector mvₖ to the evaluation value calculating unit 52ₖ.

Incidentally, of the motion vector detecting units 51₀ to 51₂, the motion vector detecting unit 51₀ for detecting a motion vector mv₀ of the Nth picture as the picture of interest supplies the motion vector mv₀ of the picture of interest to the motion information calculating unit 53 as well as to the evaluation value calculating unit 52₀.

After step S61, the process proceeds to step S62, where the motion information calculating unit 53 selects, as a pixel of interest, one of pixels that have not yet been set as a pixel of interest among the interpolation object pixels of the picture of interest, and then obtains the motion information of the pixel of interest using motion vectors mv₀ of the picture of interest (interpolation object pixels of the picture of interest) from the motion vector detecting unit 51₀.

Specifically, for example, as in step S32 in FIG. 12, the motion information calculating unit 53 obtains the average value ave₀ of Equation (1) as the motion information of the pixel of interest using the five motion vectors mv_{0, 0,} mv_{0, -1}, mv_{0, -2}, mv_{0, 1}, and mv_{0, 2} in Equation (1) which motion vectors have been described with reference to FIG. 11 and serve as motion vectors for evaluation value calculation for the pixel of interest in the picture of interest.

After step S62, the process proceeds to step S63, where the evaluation value calculating units 52₀ to 52₂ obtain three zeroth to second evaluation values using motion vectors of the three detection object pictures.

Specifically, the evaluation value calculating unit 52ₖ obtains, as a kth evaluation value mvₖ (k=0, 1, 2), an average value aveₖ and a variance disₖ of motion vectors for evaluation value calculation described with reference to FIG. 11 among the motion vectors mvₖ of the detection object picture as a picture preceding the picture of interest by k pictures.

The evaluation value calculating unit 52ₖ then supplies the average value aveₖ and the variance disₖ as the kth evaluation value to the reliability determining unit 57. The process proceeds from step S63 to step S64.

In step S64, the reliability determining unit 57 reads the determination in-progress result valid_d of reliability determination at a time preceding by the time of two pictures from the determination in-progress result storing unit 56. The process proceeds to step S65.

In step S65, the reliability determining unit 57 makes reliability determination to determine reliability of the motion information of the pixel of interest, which motion information is obtained by the motion information calculating unit 53, according to the control statement (6) using the average values ave₀ to ave₂ and the variances dis₀ to dis₂ as the zeroth to second evaluation values supplied from the evaluation value calculating units 52₀ to 52₂ and the determination in-progress result valid_d read from the determination in-progress result storing unit 56 in the immediately preceding step S64. The reliability determining unit 57 obtains reliability information indicating the reliability.

After the reliability information is obtained in step S65, the process proceeds to step S66, where the reliability determining unit 57 supplies the determination in-progress result storing unit 56 with a determination in-progress result obtained in the process of the reliability determination made in the immediately preceding step S65, that is, a determination in-progress result indicating whether the determination results of the first evaluation value determination (ABS(ave₀−ave₁)<=A) for the average values, the second evaluation value determination (ABS(ave₁−ave₂)<=A) for the average values, the first evaluation value determination (ABS(dis₀−dis₁)<=B) for the variances, and the second evaluation value determination (ABS(dis₁−dis₂)) for the variances in the control statement (6) are all true, and the reliability determining unit 57 thereby makes the determination in-progress result stored in the determination in-progress result storing unit 56. The process proceeds to step S67.

In step S67, the motion information calculating unit 53 (or the reliability determining unit 57) determines whether motion information and reliability information are obtained for all the interpolation object pixels of the picture of interest.

When it is determined in step S67 that motion information and reliability information have not yet been obtained for all the interpolation object pixels of the picture of interest, that is, that the interpolation object pixels of the picture of interest include pixels for which motion information and reliability information have not yet been obtained, the process returns to step S62, where one of the pixels for which motion information and reliability information have not yet been obtained among the interpolation object pixels of the picture of interest is set as a new pixel of interest, and the same process from step S62 on down is performed for the new pixel of interest.

When it is determined in step S67 that motion information and reliability information have been obtained for all the interpolation object pixels of the picture of interest, the process proceeds to step S68, where the motion information calculating unit 53 sequentially outputs the motion information of the interpolation object pixels of the picture of interest to the progressive image generating unit 23, and the reliability determining unit 57 sequentially outputs the reliability information for the motion information output by the motion information calculating unit 53 to the progressive image generating unit 23. Thereby the motion estimating process is ended.

As described above, as in the case of FIG. 9, the motion estimating unit 22 in FIG. 16 obtains the reliability information using in effect the picture of interest and the (N−1)th to (N−4)th pictures adjacent to the picture of interest. Therefore the reliability information that accurately indicates the reliability of the motion information can be obtained using macroblocks (corresponding blocks) of small size at the time of detecting the motion vectors.

Further, because the motion estimating unit 22 in FIG. 16 stores a determination in-progress result of reliability determination and makes reliability determination using the determination in-progress result of the past reliability determination, it is possible to miniaturize the IP converting unit 15 (FIG. 2) (and in turn the TV of FIG. 1).

That is, because the motion estimating unit 22 in FIG. 16 makes reliability determination using the determination in-progress result of the past reliability determination, it is unnecessary to obtain the third and fourth evaluation values or, in turn, the motion vectors of the picture preceding the picture of interest by three pictures and the picture preceding the picture of interest by four pictures.

In other words, it suffices for the motion estimating unit 22 in FIG. 16 to obtain the zeroth to second evaluation values or, in turn, the motion vectors of the picture of interest, the motion vectors of the picture preceding the picture of interest by one picture, and the motion vectors of the picture preceding the picture of interest by two pictures.

Therefore, when the picture of interest is the Nth picture, it suffices to supply the five (N+1)th to (N−3)th pictures including the picture of interest from the memory unit 21 to the motion estimating unit 22. The memory unit 21 in FIG. 8 can thus be formed by four frame memories 31₀ to 31₃ storing the Nth to (N−3)th pictures.

As a result, with the motion estimating unit 22 in FIG. 16, the IP converting unit 15 (FIG. 5) can be miniaturized as compared with the motion estimating unit 22 in FIG. 9 which desires that the memory unit 21 be formed by the six frame memories 31₀ to 31₅.

FIG. 18 is a block diagram showing a third example of configuration of the motion estimating unit 22 in FIG. 2.

Incidentally, in FIG. 18, parts corresponding to those of FIG. 9 are identified by the same reference numerals, and description thereof will be omitted in the following as appropriate.

The motion estimating unit 22 in FIG. 18 has evaluation value calculating units 52₀ to 52₄, a motion information calculating unit 53, and a reliability determining unit 54 in common with the motion estimating unit 22 in FIG. 9.

On the other hand, the motion estimating unit 22 in FIG. 18 differs from the motion estimating unit 22 in FIG. 9 in that the motion estimating unit 22 in FIG. 18 has one motion vector detecting unit 51₀ and four motion vector storing units 58₁ to 58₄ in place of the five motion vector detecting units 51₀ to 51₄.

The motion vector storing units 58₁ to 58₄ store the motion vectors of pictures that were a picture of interest in the past, which motion vectors are detected by the motion vector detecting unit 51₀.

Specifically, the motion vector storing unit 58₁ is supplied with the motion vector of a picture of interest from the motion vector detecting unit 51₀. The motion vector storing unit 58₁ stores the motion vector of the picture of interest supplied from the motion vector detecting unit 51₀ until the motion vector of a next picture of interest is supplied from the motion vector detecting unit 51₀. The motion vector storing unit 58₁ supplies the motion vector to the evaluation value calculating unit 52₁ and the motion vector storing unit 58₂.

Hence, when the motion vector mv₀ of the picture of interest is supplied from the motion vector detecting unit 51₀ to the motion vector storing unit 58₁, the motion vector storing unit 58₁ stores the motion vector mv₁ of a picture preceding the picture of interest by one picture. The motion vector storing unit 58₁ supplies the motion vector mv₁ to the evaluation value calculating unit 52₁ and the motion vector storing unit 58₂.

The motion vector storing unit 58₂ stores the motion vector of the picture preceding the picture of interest by one picture which motion vector is supplied from the motion vector storing unit 58₁ until the motion vector of the succeeding picture is supplied from the motion vector storing unit 58₁. The motion vector storing unit 58₂ supplies the motion vector to the evaluation value calculating unit 52₂ and the motion vector storing unit 58₃.

Hence, when the motion vector mv₁ of the picture preceding the picture of interest by one picture is supplied from the motion vector storing unit 58₁ to the motion vector storing unit 58₂, the motion vector storing unit 58₂ stores the motion vector mv₂ of a picture preceding the above picture by one picture. The motion vector storing unit 58₂ supplies the motion vector mv₂ to the evaluation value calculating unit 52₂ and the motion vector storing unit 58₃.

The motion vector storing unit 58₃ stores the motion vector of the picture preceding the picture of interest by two pictures which motion vector is supplied from the motion vector storing unit 58₂ until the motion vector of the succeeding picture is supplied from the motion vector storing unit 58₂. The motion vector storing unit 58₃ supplies the motion vector to the evaluation value calculating unit 52₃ and the motion vector storing unit 58₄.

Hence, when the motion vector mv₂ of the picture preceding the picture of interest by two pictures is supplied from the motion vector storing unit 58₂ to the motion vector storing unit 58₃, the motion vector storing unit 58₃ stores the motion vector mv₃ of a picture preceding the above picture by one picture. The motion vector storing unit 58₃ supplies the motion vector mv₃ to the evaluation value calculating unit 52₃ and the motion vector storing unit 58₄.

The motion vector storing unit 58₄ stores the motion vector of the picture preceding the picture of interest by three pictures which motion vector is supplied from the motion vector storing unit 58₃ until the motion vector of the succeeding picture is supplied from the motion vector storing unit 58₃. The motion vector storing unit 58₄ supplies the motion vector to the evaluation value calculating unit 52₄.

Hence, when the motion vector mv₃ of the picture preceding the picture of interest by three pictures is supplied from the motion vector storing unit 58₃ to the motion vector storing unit 58₄, the motion vector storing unit 58₄ stores the motion vector mv₄ of a picture preceding the above picture by one picture. The motion vector storing unit 58₄ supplies the motion vector mv₄ to the evaluation value calculating unit 52₄.

Thus, in the motion estimating unit 22 in FIG. 18, when the motion vector detecting unit 51₀ detects the motion vector mv₀ of the picture of interest and then supplies the motion vector mv₀ to the evaluation value calculating unit 52₀, the motion vector storing unit 58ₖ (k=1, 2, 3, 4) stores the motion vector mvₖ of the picture preceding the picture of interest by k pictures, and supplies the motion vector mvₖ to the evaluation value calculating unit 52ₖ.

The motion estimating unit 22 in FIG. 18 has merely one motion vector detecting unit 51₀. Thus, when the picture of interest is the Nth picture, the one motion vector detecting unit 51₀ in the motion estimating unit 22 in FIG. 18 obtains the motion vector of the Nth picture using the (N+1)th picture and the (N−1)th picture.

Therefore, when the picture of interest is the Nth picture, it suffices to supply the two (N+1)th and (N−1)th pictures necessary to obtain the motion vector of the Nth picture from the memory unit 21 to the motion estimating unit 22.

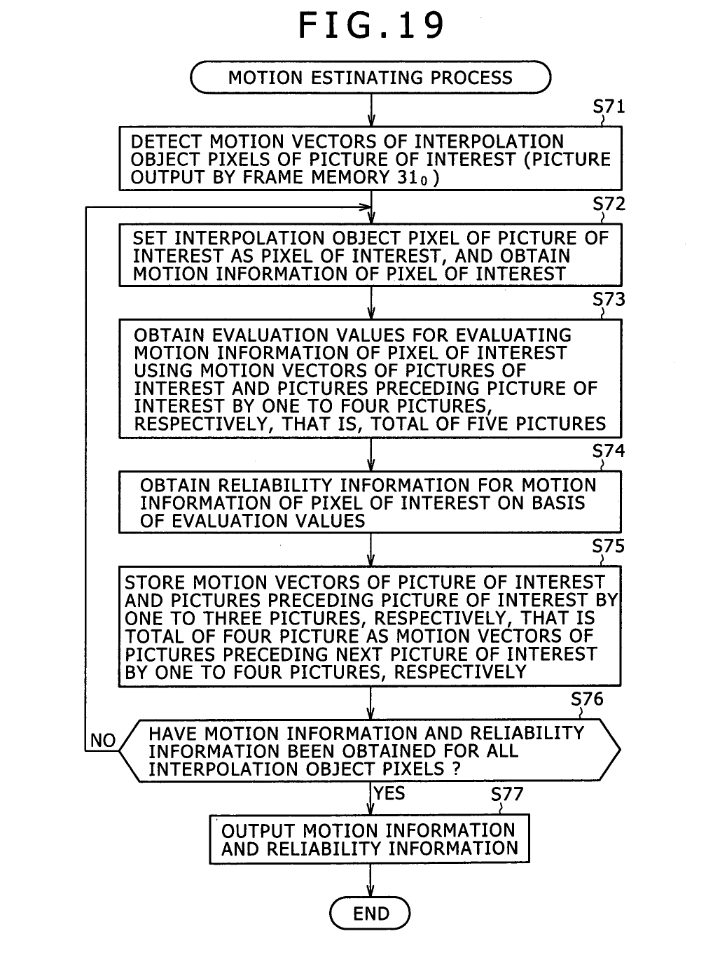

The motion estimating process performed by the motion estimating unit 22 in FIG. 18 will next be described with reference to a flowchart of FIG. 19.

In step S71 of the motion estimating process, the motion vector detecting unit 51₀ sets a picture stored in the frame memory 31₀ of the memory unit 21 (FIG. 8) as a picture of interest, further sets the picture of interest as a detection object picture, and detects the motion vector of an interpolation object pixel of the detection object picture using two pictures supplied from the memory unit 21, that is, a picture preceding the picture of interest and a picture succeeding the picture of interest.

Specifically, for example, when the picture of interest stored in the frame memory 31₀ is the Nth picture, the (N+1)th picture as the picture succeeding the picture of interest and the (N−1)th picture as the picture preceding the picture of interest are supplied from the memory unit 21 to the motion estimating unit 22.

In the motion estimating unit 22, the motion vector detecting unit 51₀ detects the motion vector mv₀ of an interpolation object pixel of the Nth picture as the picture of interest as described with reference to FIG. 7 using the (N+1)th picture as the succeeding picture succeeding the picture of interest and the (N−1)th picture as the preceding picture preceding the picture of interest, the (N+1)th picture and the (N−1)th picture being supplied from the memory unit 21. The motion vector detecting unit 51₀ then supplies the motion vector mv₀ to the evaluation value calculating unit 52₀ and the motion information calculating unit 53. The process proceeds to step S72.

In step S72, the motion information calculating unit 53 selects, as a pixel of interest, one of pixels that have not yet been set as a pixel of interest among the interpolation object pixels of the picture of interest, and then obtains the motion information of the pixel of interest using motion vectors mv₀ of the picture of interest (interpolation object pixels of the picture of interest) from the motion vector detecting unit 51₀.

Specifically, for example, as in step S32 in FIG. 12, the motion information calculating unit 53 obtains the average value ave₀ of Equation (1) as the motion information of the pixel of interest using the five motion vectors mv_{0, 0}, mv_{0, -1}, mv_{0, -2}, mv_{0, 1}, and mv_{0, 2} in Equation (1) which motion vectors have been described with reference to FIG. 11 and serve as motion vectors for evaluation value calculation for the pixel of interest in the picture of interest.

After step S72, the process proceeds to step S73, where the evaluation value calculating unit 52₀ obtains, as a zeroth evaluation value, an average value ave₀ and a variance dis₀ of the motion vectors for evaluation value calculation described with reference to FIG. 11 among the motion vectors mv₀ of the picture of interest. The evaluation value calculating unit 52₀ then supplies the average value ave₀ and the variance dis₀ as the zeroth evaluation value to the reliability determining unit 54.

Further, in step S73, the evaluation value calculating unit 52ₖ (k=1, 2, 3, 4) obtains, as a kth evaluation value, an average value aveₖ and a variance disₖ of motion vectors for evaluation value calculation described with reference to FIG. 11 among the motion vectors mvₖ of a picture preceding the picture of interest by k pictures, the motion vectors mvₖ being stored in the motion vector storing unit 58ₖ. The evaluation value calculating unit 52ₖ then supplies the average value aveₖ and the variance disₖ as the kth evaluation value to the reliability determining unit 54. The process proceeds from step S73 to step S74.

In step S74, the reliability determining unit 54 makes reliability determination to determine reliability of the motion information of the pixel of interest, which motion information is obtained by the motion information calculating unit 53, according to the control statement (5) using the average values ave₀ to ave₄ and the variances dis₀ to dis₄ as the zeroth to fourth evaluation values supplied from the evaluation value calculating units 52₀ to 52₄. The reliability determining unit 54 obtains reliability information indicating the reliability. The process proceeds to step S75.

In step S75, the motion vector storing units 58₁ to 58₄ store the motion vectors of the picture of interest and the pictures preceding the picture of interest by one to three pictures, respectively, that is, the four pictures in total, as the motion vectors of the pictures preceding, by one to four pictures, the picture succeeding the picture of interest.

Specifically, the motion vector storing unit 58₁ stores the motion vector of the picture of interest which motion vector is detected and supplied by the motion vector detecting unit 51₀. When the picture succeeding the present picture of interest by one picture becomes a new picture of interest, the motion vector stored in the motion vector storing unit 58₁ is used as the motion vector mv₁ of the picture preceding the new picture of interest by one picture.

The motion vector storing unit 58₂ stores the motion vector of the picture preceding the picture of interest by one picture which motion vector has been stored in the motion vector storing unit 58₁. When the picture succeeding the present picture of interest by one picture becomes a new picture of interest, the motion vector stored in the motion vector storing unit 58₂ is used as the motion vector mv₂ of the picture preceding the new picture of interest by two pictures.

The motion vector storing unit 58₃ stores the motion vector of the picture preceding the picture of interest by two pictures which motion vector has been stored in the motion vector storing unit 58₂. When the picture succeeding the present picture of interest by one picture becomes a new picture of interest, the motion vector stored in the motion vector storing unit 58₃ is used as the motion vector mv₃ of the picture preceding the new picture of interest by three pictures.

The motion vector storing unit 58₄ stores the motion vector of the picture preceding the picture of interest by three pictures which motion vector has been stored in the motion vector storing unit 58₃. When the picture succeeding the present picture of interest by one picture becomes a new picture of interest, the motion vector stored in the motion vector storing unit 58₄ is used as the motion vector mv₄ of the picture preceding the new picture of interest by four pictures.

After step S75, the process proceeds to step S76, where the motion information calculating unit 53 (or the reliability determining unit 54) determines whether motion information and reliability information are obtained for all the interpolation object pixels of the picture of interest.

When it is determined in step S76 that motion information and reliability information have not yet been obtained for all the interpolation object pixels of the picture of interest, that is, that the interpolation object pixels of the picture of interest include pixels for which motion information and reliability information have not yet been obtained, the process returns to step S72, where one of the pixels for which motion information and reliability information have not yet been obtained among the interpolation object pixels of the picture of interest is set as a new pixel of interest, and the same process from step S72 on down is performed for the new pixel of interest.

When it is determined in step S76 that motion information and reliability information have been obtained for all the interpolation object pixels of the picture of interest, the process proceeds to step S77, where the motion information calculating unit 53 sequentially outputs the motion information of the interpolation object pixels of the picture of interest to the progressive image generating unit 23, and the reliability determining unit 54 sequentially outputs the reliability information for the motion information output by the motion information calculating unit 53 to the progressive image generating unit 23. Thereby the motion estimating process is ended.

As described above, as in the case of FIG. 9, the motion estimating unit 22 in FIG. 18 obtains the reliability information using the picture of interest and the (N−1)th to (N−4)th pictures adjacent to the picture of interest. Therefore the reliability information that accurately indicates the reliability of the motion information can be obtained using macroblocks (corresponding blocks) of small size at the time of detecting the motion vectors.

Further, because the motion vector storing units 58₁ to 58₄ in the motion estimating unit 22 in FIG. 18 store the motion vectors of the pictures that were a picture of interest in the past, that is, the pictures preceding, by one to four pictures, the picture that is now the picture of interest, the motion vectors being detected by the motion vector detecting unit 51₀, it is possible to miniaturize the IP converting unit 15 (FIG. 2) (and in turn the TV of FIG. 1).

That is, the motion estimating unit 22 in FIG. 18 stores the motion vectors of the pictures preceding, by one to four pictures, the picture that is now the picture of interest, the motion vectors having been detected by the motion vector detecting unit 51₀ when the preceding pictures were a picture of interest. Therefore, it is unnecessary to detect the motion vectors again, and it suffices to detect the motion vector of the picture that is now the picture of interest.

Therefore, when the picture of interest is the Nth picture, it suffices to supply the two (N+1)th and (N−1)th pictures necessary to detect the motion vector of the Nth picture from the memory unit 21 to the motion estimating unit 22. The memory unit 21 in FIG. 8 can thus be formed by two frame memories 31₀ and 31₁ storing the Nth picture and the (N−1)th picture.

As a result, with the motion estimating unit 22 in FIG. 18, the IP converting unit 15 (FIG. 5) can be miniaturized as compared with the motion estimating unit 22 in FIG. 9 which desires that the memory unit 21 be formed by the six frame memories 31₀ to 31₅ or the motion estimating unit 22 in FIG. 16 which desires that the memory unit 21 be formed by the four frame memories 31₀ to 31₃.

FIG. 20 is a block diagram showing a fourth example of configuration of the motion estimating unit 22 in FIG. 2.

Incidentally, in FIG. 20, parts corresponding to those of FIG. 9, FIG. 16, or FIG. 18 are identified by the same reference numerals, and description thereof will be omitted in the following as appropriate.

The motion estimating unit 22 in FIG. 20 has three evaluation value calculating units 52₀ to 52₂, a motion information calculating unit 53, a determination in-progress result storing unit 56, and a reliability determining unit 57 in common with the motion estimating unit 22 in FIG. 16.

On the other hand, the motion estimating unit 22 in FIG. 20 differs from the motion estimating unit 22 in FIG. 16 in that the motion estimating unit 22 in FIG. 20 has one motion vector detecting unit 51₀ and two motion vector storing units 58₁ and 58₂ in FIG. 18 in place of the three motion vector detecting units 51₀ to 51₂.

As described with reference to FIG. 18, the motion vector storing units 58₁ and 58₂ store the motion vectors of pictures that were a picture of interest in the past, which motion vectors are detected by the motion vector detecting unit 51₀.

Specifically, the motion vector storing unit 58₁ is supplied with the motion vector of a picture of interest from the motion vector detecting unit 51₀. The motion vector storing unit 58₁ stores the motion vector of the picture of interest supplied from the motion vector detecting unit 51₀ until the motion vector of a next picture of interest is supplied from the motion vector detecting unit 51₀. The motion vector storing unit 58₁ supplies the motion vector to the evaluation value calculating unit 52₁ and the motion vector storing unit 58₂.

Hence, when the motion vector mv₀ of the picture of interest is supplied from the motion vector detecting unit 51₀ to the motion vector storing unit 58₁, the motion vector storing unit 58₁ stores the motion vector mv₁ of a picture preceding the picture of interest by one picture. The motion vector storing unit 58₁ supplies the motion vector mv₁ to the evaluation value calculating unit 52₁ and the motion vector storing unit 58₂.

The motion vector storing unit 58₂ stores the motion vector of the picture preceding the picture of interest by one picture which motion vector is supplied from the motion vector storing unit 58₁ until the motion vector of the succeeding picture is supplied from the motion vector storing unit 58₁. The motion vector storing unit 58₂ supplies the motion vector to the evaluation value calculating unit 52₂.

Hence, when the motion vector mv₁ of the picture preceding the picture of interest by one picture is supplied from the motion vector storing unit 58₁ to the motion vector storing unit 58₂, the motion vector storing unit 58₂ stores the motion vector mv₂ of a picture preceding the above picture by one picture. The motion vector storing unit 58₂ supplies the motion vector mv₂ to the evaluation value calculating unit 52₂.

Thus, in the motion estimating unit 22 in FIG. 20, when the motion vector detecting unit 51₀ detects the motion vector mv₀ of the picture of interest and then supplies the motion vector mv₀ to the evaluation value calculating unit 52₀, the motion vector storing unit 58ₖ (k=1, 2) stores the motion vector mvₖ of the picture preceding the picture of interest by k pictures, and supplies the motion vector mvₖ to the evaluation value calculating unit 52ₖ.

The motion estimating unit 22 in FIG. 20 has merely one motion vector detecting unit 51₀. Thus, when the picture of interest is the Nth picture, the one motion vector detecting unit 51₀ in the motion estimating unit 22 in FIG. 20 obtains the motion vector of the Nth picture using the (N+1)th picture and the (N−1)th picture.

Therefore, when the picture of interest is the Nth picture, as in the case of FIG. 18, it suffices to supply the two (N+1)th and (N−1)th pictures necessary to obtain the motion vector of the Nth picture from the memory unit 21 to the motion estimating unit 22.

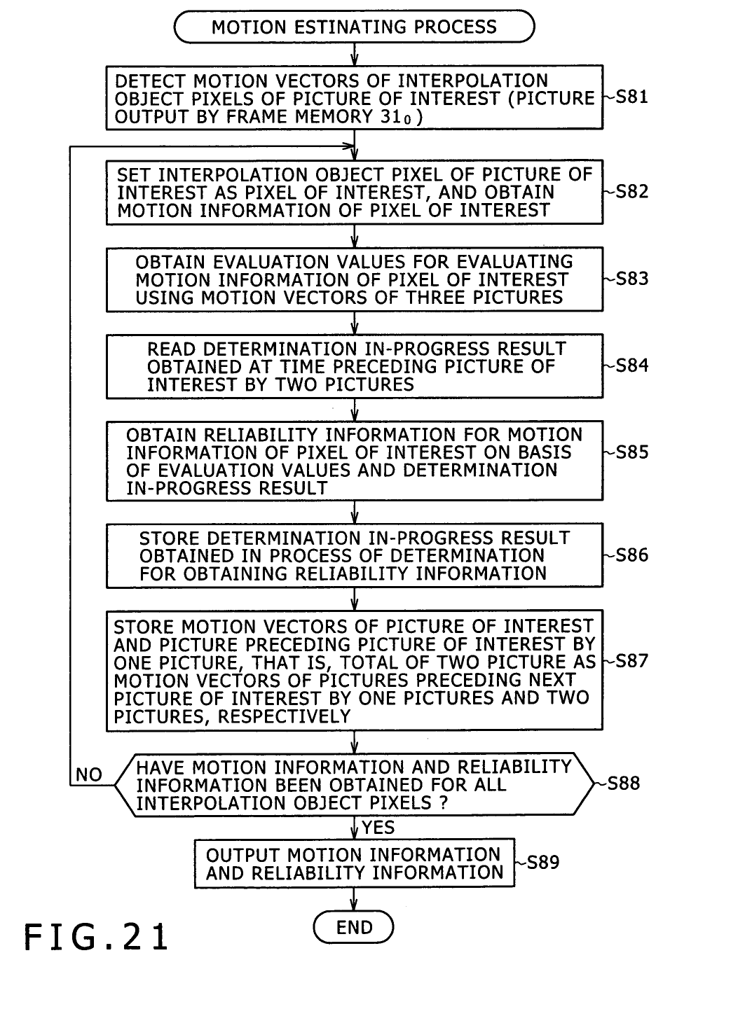

The motion estimating process performed by the motion estimating unit 22 in FIG. 20 will next be described with reference to a flowchart of FIG. 21.

In step S81 of the motion estimating process, the motion vector detecting unit 51₀ sets a picture stored in the frame memory 31₀ of the memory unit 21 (FIG. 8) as a picture of interest, further sets the picture of interest as a detection object picture, and detects the motion vector of an interpolation object pixel of the detection object picture using two pictures supplied from the memory unit 21, that is, a picture preceding the picture of interest and a picture succeeding the picture of interest.

Specifically, for example, when the picture of interest stored in the frame memory 31₀ is the Nth picture, the (N+1)th picture as the picture succeeding the picture of interest and the (N−1)th picture as the picture preceding the picture of interest are supplied from the memory unit 21 to the motion estimating unit 22.

In the motion estimating unit 22, the motion vector detecting unit 51₀ detects the motion vector mv₀ of an interpolation object pixel of the Nth picture as the picture of interest as described with reference to FIG. 7 using the (N+1)th picture as the succeeding picture succeeding the picture of interest and the (N−1)th picture as the preceding picture preceding the picture of interest, the (N+1)th picture and the (N−1)th picture being supplied from the memory unit 21. The motion vector detecting unit 51₀ then supplies the motion vector mv₀ to the evaluation value calculating unit 52₀ and the motion information calculating unit 53. The process proceeds to step S82.

In step S82, the motion information calculating unit 53 selects, as a pixel of interest, one of pixels that have not yet been set as a pixel of interest among the interpolation object pixels of the picture of interest, and then obtains the motion information of the pixel of interest using motion vectors mv₀ of the picture of interest (interpolation object pixels of the picture of interest) from the motion vector detecting unit 51₀.

Specifically, for example, as in step S32 in FIG. 12, the motion information calculating unit 53 obtains the average value ave₀ of Equation (1) as the motion information of the pixel of interest using the five motion vectors mv_{0, 0,} mv_{0, -1}, mv_{0, -2}, mv_{0, 1}, and mv_{0, 2} in Equation (1) which motion vectors have been described with reference to FIG. 11 and serve as motion vectors for evaluation value calculation for the pixel of interest in the picture of interest.

After step S82, the process proceeds to step S83, where the evaluation value calculating unit 52₀ obtains, as a zeroth evaluation value, an average value ave₀ and a variance dis₀ of the motion vectors for evaluation value calculation described with reference to FIG. 11 among the motion vectors mv₀ of the picture of interest. The evaluation value calculating unit 52₀ then supplies the average value ave₀ and the variance dis₀ as the zeroth evaluation value to the reliability determining unit 57.

Further, in step S83, the evaluation value calculating unit 52₁ obtains, as a first evaluation value, an average value ave₁ and a variance dis₁ of motion vectors for evaluation value calculation described with reference to FIG. 11 among the motion vectors mv₁ of a picture preceding the picture of interest by one picture, the motion vectors mv₁ being stored in the motion vector storing unit 58₁. The evaluation value calculating unit 52₁ then supplies the average value ave₁ and the variance dis₁ as the first evaluation value to the reliability determining unit 57.

In addition, in step S83, the evaluation value calculating unit 52₂ obtains, as a second evaluation value, an average value ave₂ and a variance dis₂ of motion vectors for evaluation value calculation described with reference to FIG. 11 among the motion vectors mv₂ of a picture preceding the picture of interest by two pictures, the motion vectors mv₂ being stored in the motion vector storing unit 58₂. The evaluation value calculating unit 52₂ then supplies the average value ave₂ and the variance dis₂ as the second evaluation value to the reliability determining unit 57. The process proceeds from step S83 to step S84.

In step S84, the reliability determining unit 57 reads the determination in-progress result valid_d of reliability determination at a time preceding by the time of two pictures from the determination in-progress result storing unit 56. The process proceeds to step S85.

In step S85, the reliability determining unit 57 makes reliability determination to determine reliability of the motion information of the pixel of interest, which motion information is obtained by the motion information calculating unit 53, according to the control statement (6) using the average values ave₀ to ave₂ and the variances dis₀ to dis₂ as the zeroth to second evaluation values supplied from the evaluation value calculating units 52₀ to 52₂ and the determination in-progress result valid_d read from the determination in-progress result storing unit 56 in the immediately preceding step S84. The reliability determining unit 57 obtains reliability information indicating the reliability.

After the reliability information is obtained in step S85, the process proceeds to step S86, where the reliability determining unit 57 supplies the determination in-progress result storing unit 56 with a determination in-progress result obtained in the process of the reliability determination made in the immediately preceding step S85, that is, a determination in-progress result indicating whether the determination results of the first evaluation value determination (ABS(ave₀−ave₁)<=A) for the average values, the second evaluation value determination (ABS(ave₁−ave₂)<=A) for the average values, the first evaluation value determination (ABS(dis₀−dis₁)<=B) for the variances, and the second evaluation value determination (ABS(dis₁−dis₂)) for the variances in the control statement (6) are all true, and the reliability determining unit 57 thereby makes the determination in-progress result stored in the determination in-progress result storing unit 56. The process proceeds to step S87.

In step S87, the motion vector storing units 58₁ and 58₂ store the motion vectors of the picture of interest and the picture preceding the picture of interest by one picture, that is, the two pictures in total as the motion vectors of the pictures preceding, by one picture and two pictures, respectively, the picture succeeding the picture of interest.

Specifically, the motion vector storing unit 58₁ stores the motion vector of the picture of interest which motion vector is detected and supplied by the motion vector detecting unit 51₀. When the picture succeeding the present picture of interest by one picture becomes a new picture of interest, the motion vector stored in the motion vector storing unit 58₁ is used as the motion vector mv₁ of the picture preceding the new picture of interest by one picture.

The motion vector storing unit 58₂ stores the motion vector of the picture preceding the picture of interest by one picture which motion vector has been stored in the motion vector storing unit 58₁. When the picture succeeding the present picture of interest by one picture becomes a new picture of interest, the motion vector stored in the motion vector storing unit 58₂ is used as the motion vector mv₂ of the picture preceding the new picture of interest by two pictures.

After step S87, the process proceeds to step S88, where the motion information calculating unit 53 (or the reliability determining unit 57) determines whether motion information and reliability information are obtained for all the interpolation object pixels of the picture of interest.

When it is determined in step S88 that motion information and reliability information have not yet been obtained for all the interpolation object pixels of the picture of interest, that is, that the interpolation object pixels of the picture of interest include pixels for which motion information and reliability information have not yet been obtained, the process returns to step S82, where one of the pixels for which motion information and reliability information have not yet been obtained among the interpolation object pixels of the picture of interest is set as a new pixel of interest, and the same process from step S82 on down is performed for the new pixel of interest.

When it is determined in step S88 that motion information and reliability information have been obtained for all the interpolation object pixels of the picture of interest, the process proceeds to step S89, where the motion information calculating unit 53 sequentially outputs the motion information of the interpolation object pixels of the picture of interest to the progressive image generating unit 23, and the reliability determining unit 57 sequentially outputs the reliability information for the motion information output by the motion information calculating unit 53 to the progressive image generating unit 23. Thereby the motion estimating process is ended.

As described above, as in the case of FIG. 9, the motion estimating unit 22 in FIG. 20 obtains the reliability information using in effect the picture of interest and the (N−1)th to (N−4)th pictures adjacent to the picture of interest. Therefore the reliability information that accurately indicates the reliability of the motion information can be obtained using macroblocks (corresponding blocks) of small size at the time of detecting the motion vectors.

Further, in the motion estimating unit 22 in FIG. 20, the motion vector storing units 58₁ and 58₂ store the motion vectors of the pictures that were a picture of interest in the past, that is, the pictures preceding, by one and two pictures, the picture that is now the picture of interest, the motion vectors being detected by the motion vector detecting unit 51₀, and the determination in-progress result storing unit 56 stores a determination in-progress result of reliability determination so that reliability determination is made using the determination in-progress result of the past reliability determination. Therefore it is possible to further miniaturize the IP converting unit 15 (FIG. 2) (and in turn the TV of FIG. 1).

That is, because the motion estimating unit 22 in FIG. 20 makes reliability determination using the determination in-progress result of the past reliability determination, it is unnecessary to detect or store the third and fourth evaluation values or, in turn, the motion vectors of the picture preceding the picture of interest by three pictures and the picture preceding the picture of interest by four pictures.

In other words, the motion estimating unit 22 in FIG. 20 can make the same reliability determination as in the case of FIG. 9 with the zeroth to second evaluation values or, in turn, the motion vectors of the picture of interest, the picture preceding the picture of interest by one picture, and the picture preceding the picture of interest by two pictures, that is, the three pictures in total.

Further, the motion estimating unit 22 in FIG. 20 stores the motion vectors of the pictures preceding, by one and two pictures, the picture that is now the picture of interest, the motion vectors having been detected when the preceding pictures were a picture of interest. Therefore, it is unnecessary to detect the motion vectors again, and it suffices to detect the motion vector of the picture that is now the picture of interest.

Therefore, when the picture of interest is the Nth picture, it suffices to supply the two (N+1)th and (N−1)th pictures necessary to detect the motion vector of the Nth picture from the memory unit 21 to the motion estimating unit 22. The memory unit 21 in FIG. 8 can thus be formed by two frame memories 31₀ and 31₁ storing the Nth picture and the (N−1)th picture.

Further, the motion estimating unit 22 in FIG. 20 stores the determination in-progress result of the past reliability determination instead of obtaining the third and fourth evaluation values or, in turn, obtaining (storing) the motion vectors of the picture preceding the picture of interest by three pictures and the picture preceding the picture of interest by four pictures. Therefore, providing one determination in-progress result storing unit 56 storing the determination in-progress result eliminates a need for providing the two motion vector storing units 58₃ and 58₄ and the two evaluation value calculating units 52₃ and 52₄ in FIG. 18.

As a result, with the motion estimating unit 22 in FIG. 20, the IP converting unit 15 (FIG. 2) can be miniaturized as compared with the motion estimating unit 22 in FIG. 18.

The series of processes of the motion estimating unit 22 and the progressive image generating unit 23 in the IP converting unit 15 (FIG. 2) described above can be carried out by hardware and also carried out by software. When the series of processes is to be carried out by software, a program constituting the software is installed onto a general-purpose personal computer or the like.

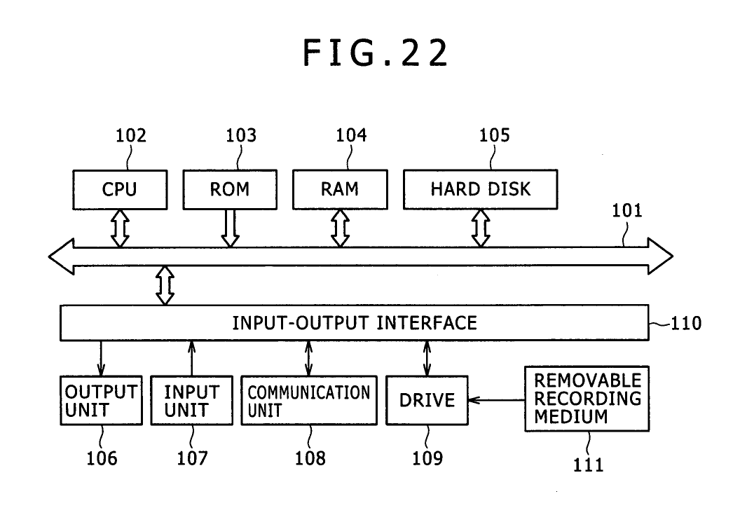

FIG. 22 shows an example of configuration of an embodiment of a computer on which the program for carrying out the above-described series of processes is installed.

The program can be recorded in advance on a hard disk 105 as a recording medium included in the computer or in a ROM 103.

Alternatively, the program can be stored (recorded) temporarily or permanently on a removable recording medium 111 such as a flexible disk, a CD-ROM (Compact Disk Read Only Memory), an MO (Magneto-Optical) disk, a DVD (Digital Versatile Disk), a magnetic disk, a semiconductor memory or the like. Such a removable recording medium 111 can be provided as so-called packaged software.

Incidentally, in addition to being installed from the removable recording medium 111 as described above onto the computer, the program can be transferred from a download site to the computer by radio via an artificial satellite for digital satellite broadcasting, or transferred to the computer by wire via a network such as a LAN (Local Area Network), the Internet and the like, and the computer can receive the thus transferred program by a communication unit 108 and install the program onto the built-in hard disk 105.

The computer includes a CPU (Central Processing Unit) 102. The CPU 102 is connected with an input-output interface 110 via a bus 101. When a user inputs a command via the input-output interface 110 by for example operating an input unit 107 formed by a keyboard, a mouse, a microphone and the like, the CPU 102 executes a program stored in the ROM (Read Only Memory) 103 according to the command. Alternatively, the CPU 102 loads, into a RAM (Random Access Memory) 104, the program stored on the hard disk 105, the program transferred from the satellite or the network, received by the communication unit 108, and then installed onto the hard disk 105, or the program read from the removable recording medium 111 loaded in a drive 109 and then installed onto the hard disk 105. The CPU 102 then executes the program. The CPU 102 thereby performs the processes according to the above-described flowcharts or the processes performed by the configurations of the block diagrams described above. Then, as desired, the CPU 102 for example outputs a result of the processes from an output unit 106 formed by an LCD (Liquid Crystal Display), a speaker and the like via the input-output interface 110, transmits the result from the communication unit 108, or records the result onto the hard disk 105.

In the present specification, the process steps describing the program for making a computer perform various processes do not necessarily need to be performed in time series in the order described in the flowcharts, and include processes performed in parallel or individually (for example parallel processing or processing based on an object).

The program may be processed by one computer, or may be subjected to distributed processing by a plurality of computers.

While description has been made of a case where the embodiment of the present invention is applied to IP conversion that converts an interlaced image to a progressive image, the embodiment of the present invention is also applicable to image processing devices that obtain motion information from an image.

In addition, while motion information is obtained in a pixel unit in the present embodiment, it is possible to divide an image into blocks formed by a plurality of pixels and obtain motion information in the units of the blocks. However, obtaining motion information in the unit of a block can be regarded as obtaining motion information of one pixel forming the block and setting the motion information as motion information of all pixels forming the block, and is thus after all equivalent to obtaining motion information in a pixel unit.

It is to be noted that embodiments of the present invention are not limited to the foregoing embodiments, and are susceptible of various changes without departing from the spirit of the embodiment of the present invention.

It should be understood by those skilled in the art that various modifications, combinations, sub-combinations and alterations may occur depending on design requirements and other factor in so far as they are within the scope of the appended claims or the equivalents thereof.

What is claimed is:

1. An image processing device for obtaining motion information indicating a motion of an image, said image processing device comprising:
motion estimating means for
obtaining motion information of a pixel of interest to which attention is directed among pixels of a picture of interest to which attention is directed, using a motion vector of said pixel of interest and a motion vector of a pixel in vicinity of said pixel of interest, and outputting the motion information of said pixel of interest, and
obtaining an evaluation value for evaluating the motion information of said pixel of interest using motion vectors of a plurality of pixels of said picture of interest, obtaining an evaluation value for evaluating the motion information of said pixel of interest using motion vectors of a plurality of pixels of another picture adjacent to said picture of interest, determining reliability of the motion information of said pixel of interest using said evaluation values, and outputting reliability information indicating the reliability.

2. The image processing device according to claim 1, wherein
said motion estimating means includes:
one motion vector detecting means for detecting a motion vector of a pixel of a picture of interest;
a plurality of motion vector storing means for storing detected motion vectors of pixels of a plurality of pictures that have been a picture of interest in a past;
motion information calculating means for obtaining motion information of a pixel of interest using a motion vector of said pixel of interest and a motion vector of a pixel in vicinity of said pixel of interest, the motion vectors being detected by said motion vector detecting means;
a plurality of evaluation value calculating means for obtaining evaluation values for evaluating the motion information of said pixel of interest, using the detected motion vectors of said picture of interest and said plurality of pictures;
determination in-progress result storing means for storing a determination in-progress result, which is an in-progress result of reliability determination that determines reliability of motion information; and
reliability determining means for making reliability determination that determines reliability of the motion information of said pixel of interest using the evaluation values obtained by said plurality of evaluation value calculating means and the determination in-progress result of the past reliability determination, the determination in-progress result of the past reliability determination being stored by said determination in-progress result storing means, and making said determination in-progress result storing means store a determination in-progress result of the reliability determination.

3. The image processing device according to claim 1, wherein
said motion estimating means includes:
a plurality of motion vector detecting means for detecting a motion vector of a pixel of a plurality of pictures, the plurality of pictures being a picture of interest and one or more other pictures adjacent to said picture of interest;
motion information calculating means for obtaining motion information of a pixel of interest using a motion vector of said pixel of interest and a motion vector of a pixel in vicinity of said pixel of interest, the motion vectors being detected by said motion vector detecting means for said picture of interest among said plurality of motion vector detecting means;
a plurality of evaluation value calculating means for obtaining evaluation values for evaluating the motion information of said pixel of interest, using motion vectors detected by said plurality of motion vector detecting means; and
reliability determining means for determining reliability of the motion information of said pixel of interest using the evaluation values obtained by said plurality of evaluation value calculating means.

4. The image processing device according to claim 1, wherein
said motion estimating means includes:
a plurality of motion vector detecting means for detecting a motion vector of a pixel of a plurality of pictures, the plurality of pictures being a picture of interest and one or more other pictures adjacent to said picture of interest;
motion information calculating means for obtaining motion information of a pixel of interest using a motion vector of said pixel of interest and a motion vector of a pixel in vicinity of said pixel of interest, the motion vectors being detected by said motion vector detecting means for said picture of interest among said plurality of motion vector detecting means;
a plurality of evaluation value calculating means for obtaining evaluation values for evaluating the motion information of said pixel of interest, using motion vectors detected by said plurality of motion vector detecting means;
determination in-progress result storing means for storing a determination in-progress result, which is an in-progress result of reliability determination that determines reliability of motion information; and
reliability determining means for making reliability determination that determines reliability of the motion information of said pixel of interest using the evaluation values obtained by said plurality of evaluation value calculating means and the determination in-progress result of the past reliability determination, the determination in-progress result of the past reliability determination being stored by said determination in-progress result storing means, and making said determination in-progress result storing means store a determination in-progress result of the reliability determination.

5. The image processing device according to claim 1, wherein
said motion estimating means includes:
one motion vector detecting means for detecting a motion vector of a pixel of a picture of interest;
a plurality of motion vector storing means for storing detected motion vectors of pixels of a plurality of pictures that have been a picture of interest in a past;
motion information calculating means for obtaining motion information of a pixel of interest using a motion vector of said pixel of interest and a motion vector of a pixel in vicinity of said pixel of interest, the motion vectors being detected by said motion vector detecting means;
a plurality of evaluation value calculating means for obtaining evaluation values for evaluating the motion information of said pixel of interest, using the detected motion vectors of said picture of interest and said plurality of pictures; and
reliability determining means for determining reliability of the motion information of said pixel of interest using the evaluation values obtained by said plurality of evaluation value calculating means.

6. The image processing device according to claim 1, wherein
said motion estimating means obtains one or both of an average value and a variance of the motion vectors of said plurality of pixels as said evaluation value.

7. The image processing device according to claim 1, wherein
said motion estimating means determines that the motion information of said pixel of interest is reliable when a determination result of evaluation value determination determining whether a difference between said evaluation values obtained for two pictures adjacent to each other is equal to or smaller than a predetermined threshold value is true, such determination being made for all sets of two pictures adjacent to each other of a plurality of consecutive pictures including said picture of interest, and
said motion estimating means determines that the motion information of said pixel of interest is unreliable when a determination result of evaluation value determination for at least one set is false.

8. The image processing device according to claim 1, further comprising:
progressive image generating means for generating a progressive image from an interlaced image,
said progressive image generating means including
first interpolating means for obtaining a first interpolation value for said pixel of interest using a pixel value of another pixel of said picture of interest,
second interpolating means for obtaining a second interpolation value for said pixel of interest using a pixel value of a pixel of a picture adjacent to said picture of interest and the motion information of the pixel of interest, and
selecting means for selecting said first interpolation value and outputting said first interpolation value as pixel value of said pixel of interest when said reliability information indicates that said motion information is unreliable, and selecting said second interpolation value and outputting said second interpolation value as pixel value of said pixel of interest when said reliability information indicates that said motion information is reliable.

9. An image processing method of an image processing device for obtaining motion information indicating a motion of an image, said image processing method comprising a step of:
obtaining motion information of a pixel of interest to which attention is directed among pixels of a picture of interest to which attention is directed, using a motion vector of said pixel of interest and a motion vector of a pixel in vicinity of said pixel of interest, and outputting the motion information of said pixel of interest, and
obtaining an evaluation value for evaluating the motion information of said pixel of interest using motion vectors of a plurality of pixels of said picture of interest, obtaining an evaluation value for evaluating the motion information of said pixel of interest using motion vectors of a plurality of pixels of another picture adjacent to said picture of interest, determining reliability of the motion information of said pixel of interest using said evaluation values, and outputting reliability information indicating the reliability.

10. A program for making a computer function as an image processing device for obtaining motion information indicating a motion of an image, said image processing device including motion estimating means for:
obtaining motion information of a pixel of interest to which attention is directed among pixels of a picture of interest to which attention is directed, using a motion vector of said pixel of interest and a motion vector of a pixel in vicinity of said pixel of interest, and outputting the motion information of said pixel of interest, and
obtaining an evaluation value for evaluating the motion information of said pixel of interest using motion vectors of a plurality of pixels of said picture of interest, obtaining an evaluation value for evaluating the motion information of said pixel of interest using motion vectors of a plurality of pixels of another picture adjacent to said picture of interest, determining reliability of the motion information of said pixel of interest using said evaluation values, and outputting reliability information indicating the reliability.

11. A display device for displaying an image of a broadcast program, said display device comprising:
receiving means for receiving said broadcast program;
motion estimating means for
obtaining motion information of a pixel of interest to which attention is directed among pixels of a picture of interest to which attention is directed among pictures constituting the image of said broadcast program, using a motion vector of said pixel of interest and a motion vector of a pixel in vicinity of said pixel of interest, and outputting the motion information of said pixel of interest, and
obtaining an evaluation value for evaluating the motion information of said pixel of interest using motion vectors of a plurality of pixels of said picture of interest, obtaining an evaluation value for evaluating the motion information of said pixel of interest using motion vectors of a plurality of pixels of another picture adjacent to said picture of interest, determining reliability of the motion information of said pixel of interest using said evaluation values, and outputting reliability information indicating the reliability;
progressive image generating means for obtaining a first interpolation value for said pixel of interest using a pixel value of another pixel of said picture of interest and obtaining a second interpolation value for said pixel of interest using a pixel value of a pixel of a picture adjacent to said picture of interest and the motion information of said pixel of interest, and
selecting said first interpolation value and outputting said first interpolation value as pixel value of said pixel of interest when said reliability information indicates that said motion information is unreliable, and selecting said second interpolation value and outputting said second interpolation value as pixel value of said pixel of interest when said reliability information indicates that said motion information is reliable, whereby a progressive image is generated from an interlaced image; and
displaying means for displaying said progressive image.

12. An image processing device for obtaining motion information indicating a motion of an image, said image processing device comprising:
a motion estimating section configured to
obtain motion information of a pixel of interest to which attention is directed among pixels of a picture of interest to which attention is directed, using a motion vector of said pixel of interest and a motion vector of a pixel in vicinity of said pixel of interest, and output the motion information of said pixel of interest, and
obtain an evaluation value for evaluating the motion information of said pixel of interest using motion vectors of a plurality of pixels of said picture of interest, obtain an evaluation value for evaluating the motion information of said pixel of interest use motion vectors of a plurality of pixels of another picture adjacent to said picture of interest, determine reliability of the motion information of said pixel of interest using said evaluation values, and output reliability information indicating the reliability.

13. A display device for displaying an image of a broadcast program, said display device comprising:
a receiving section configured to receive said broadcast program;
a motion estimating section configured to obtain motion information of a pixel of interest to which attention is directed among pixels of a picture of interest to which attention is directed among pictures constituting the image of said broadcast program, using a motion vector of said pixel of interest and a motion vector of a pixel in vicinity of said pixel of interest, and output the motion information of said pixel of interest, and
obtain an evaluation value for evaluating the motion information of said pixel of interest using motion vectors of a plurality of pixels of said picture of interest, obtain an evaluation value for evaluating the motion information of said pixel of interest using motion vectors of a plurality of pixels of another picture adjacent to said picture of interest, determine reliability of the motion information of said pixel of interest using said evaluation values, and output reliability information indicating the reliability;
a progressive image generating section configured to obtain a first interpolation value for said pixel of interest using a pixel value of another pixel of said picture of interest and obtain a second interpolation value for said pixel of interest using a pixel value of a pixel of a picture adjacent to said picture of interest and the motion information of said pixel of interest, and
select said first interpolation value and output said first interpolation value as pixel value of said pixel of interest when said reliability information indicates that said motion information is unreliable, and select said second interpolation value and output said second interpolation value as pixel value of said pixel of interest when said reliability information indicates that said motion information is reliable, whereby a progressive image is generated from an interlaced image; and
a displaying section configured to display said progressive image.
